(19) United States
(12) Patent Application Publication
(10) Pub. No.: US 2026/0238822 A1
(43) Pub. Date: Aug. 13, 2026

(54) THREE-DIMENSIONAL DATA DECODING METHOD AND THREE-DIMENSIONAL DATA ENCODING METHOD

(71) Applicant: Panasonic Intellectual Property Corporation of America, Torrance, CA (US)

(72) Inventors: Masato OHKAWA, Toyama (JP); Noritaka IGUCHI, Osaka (JP); Toshiyasu SUGIO, Osaka (JP); Takahiro NISHI, Nara (JP)

(21) Appl. No.: 19/633,191

(22) Filed: Mar. 30, 2026

Related U.S. Application Data
(63) Continuation of application No. 18/678,344, filed on May 30, 2024, now abandoned.
Application No. 18/678,344 is a continuation of application No. PCT/JP2022/039442, filed on Oct. 24, 2022.
(60) Provisional application No. 63/287,619, filed on Dec. 9, 2021.

(51) Int. Cl. H04N 19/70; H04N 19/119; H04N 19/176; H04N 19/18; H04N 19/597; H04N 19/60

(52) U.S. Cl. CPC H04N 19/70; H04N 19/119; H04N 19/176; H04N 19/18; H04N 19/597; H04N 19/60

(57) ABSTRACT

A three-dimensional data decoding method includes: obtaining control information indicating that first attribute information of a three-dimensional point and second attribute information of the three-dimensional point are to be merged; and decoding the first attribute information and the second attribute information according to the control information. The first attribute information and the second attribute information each have a predetermined length compliant with a point cloud compression standard.

### CROSS REFERENCE TO RELATED APPLICATIONS

This application is a continuation of U.S. application Ser. No. 18/678,344 filed on May 30, 2024, which is a continuation application of PCT International Patent Application Number PCT/JP2022/039442 filed on Oct. 24, 2022, claiming the benefit of priority of U.S. Provisional Application Number 63/287619 filed on Dec. 9, 2021. The entire disclosures of the above-identified applications, including the specifications, drawings, and claims are incorporated herein by reference in their entirety.

### FIELD

The present disclosure relates to a three-dimensional data decoding method, a three-dimensional data encoding method, a three-dimensional data decoding device, and a three-dimensional data encoding device.

### BACKGROUND

Devices or services utilizing three-dimensional data are expected to find their widespread use in a wide range of fields, such as computer vision that enables autonomous operations of cars or robots, map information, monitoring, infrastructure inspection, and video distribution. Three-dimensional data is obtained through various means including a distance sensor such as a rangefinder, as well as a stereo camera and a combination of a plurality of monocular cameras.

Methods of representing three-dimensional data include a method known as a point cloud scheme that represents the shape of a three-dimensional structure by a point cloud in a three-dimensional space. In the point cloud scheme, the positions and colors of a point cloud are stored. While point cloud is expected to be a mainstream method of representing three-dimensional data, a massive amount of data of a point cloud necessitates compression of the amount of three-dimensional data by encoding for accumulation and transmission, as in the case of a two-dimensional moving picture (examples include Moving Picture Experts Group-4 Advanced Video Coding (MPEG-4 AVC) and High Efficiency Video Coding (HEVC) standardized by MPEG).

Meanwhile, point cloud compression is partially supported by, for example, an open-source library (Point Cloud Library) for point cloud-related processing.

Furthermore, a technique for searching for and displaying a facility located in the surroundings of the vehicle by using three-dimensional map data is known (see, for example, Patent Literature (PTL) 1).

### CITATION LIST

### Patent Literature

PTL 1: International Publication WO 2014/020663

### SUMMARY

### Technical Problem

In encoding processing and decoding processing of three-dimensional data, attribute information that exceeds a length compliant with a point cloud compression standard cannot be processed.

The present disclosure provides a three-dimensional data decoding method, a three-dimensional data encoding method, a three-dimensional data decoding device, or a three-dimensional data encoding device capable of processing attribute information that exceeds a length compliant with a point cloud compression standard.

### Solution to Problem

A three-dimensional data decoding method according to an aspect of the present disclosure includes: obtaining control information indicating that first attribute information of a three-dimensional point and second attribute information of the three-dimensional point are to be merged; and decoding the first attribute information and the second attribute information according to the control information, wherein the first attribute information and the second attribute information each have a predetermined length compliant with a point cloud compression standard.

A three-dimensional data decoding method according to an aspect of the present disclosure includes: obtaining control information indicating that attribute information of a three-dimensional point is provided over a plurality of sub-blocks each having a predetermined length compliant with a point cloud compression standard; and decoding the attribute information according to the control information.

A three-dimensional data encoding method according to an aspect of the present disclosure includes: generating control information indicating that first attribute information of a three-dimensional point and second attribute information of the three-dimensional point are to be merged; encoding the first attribute information and the second attribute information; and generating a bitstream including the first attribute information and the second attribute information that have been encoded and the control information, wherein the first attribute information and the second attribute information each have a predetermined length compliant with a point cloud compression standard.

A three-dimensional data encoding method according to an aspect of the present disclosure includes: generating control information indicating that attribute information of a three-dimensional point is provided over a plurality of sub-blocks each having a predetermined length compliant with a point cloud compression standard; encoding the attribute information; and generating a bitstream including the attribute information that has been encoded and the control information.

### Advantageous Effects

The present disclosure can provide a three-dimensional data decoding method, a three-dimensional data encoding method, a three-dimensional data decoding device, or a three-dimensional data encoding device capable of processing attribute information that exceeds a length compliant with a point cloud compression standard.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating an example of geometry information and attribute information of a point cloud according to an embodiment.

FIG. 2 is a block diagram of a three-dimensional data encoding device according to the embodiment.

FIG. 3 is a block diagram of a three-dimensional data decoding device according to the embodiment.

FIG. 4 is a diagram illustrating an example of partitioning of input attribute information into a plurality of items of transformed attribute information according to the embodiment.

FIG. 5 is a diagram illustrating an example of a correspondence relationship between a plurality of items of transformed attribute information and a component and subcomponents according to the embodiment.

FIG. 6 is a diagram illustrating an example of a correspondence relationship between a plurality of items of transformed attribute information and components and subcomponents according to the embodiment.

FIG. 7 is a diagram illustrating an example of a correspondence relationship between a plurality of items of transformed attribute information and components and subcomponents according to the embodiment.

FIG. 8 is a diagram illustrating an example of transforming processing according to the embodiment.

FIG. 9 is a flowchart of transforming processing according to the embodiment.

FIG. 10 is a diagram illustrating an example of inverse transforming processing according to the embodiment.

FIG. 11 is a flowchart of inverse transforming processing according to the embodiment.

FIG. 12 is a diagram illustrating a first specific example of transforming processing according to the embodiment.

FIG. 13 is a diagram illustrating a first specific example of inverse transforming processing according to the embodiment.

FIG. 14 is a diagram illustrating a second specific example of transforming processing according to the embodiment.

FIG. 15 is a diagram illustrating a second specific example of inverse transforming processing according to the embodiment.

FIG. 16 is a block diagram illustrating a variation of a three-dimensional data encoding device according to the embodiment.

FIG. 17 is a block diagram illustrating a variation of a three-dimensional data decoding device according to the embodiment.

FIG. 18 is a block diagram illustrating an example of a syntax of common information according to the embodiment.

FIG. 19 is a block diagram illustrating an example of a syntax of individual information according to the embodiment.

FIG. 20 is a diagram illustrating an example configuration of a bitstream according to the embodiment.

FIG. 21 is a diagram illustrating an example configuration of a bitstream according to the embodiment.

FIG. 22 is a diagram illustrating an example configuration of a bitstream according to the embodiment.

FIG. 23 is a diagram illustrating an example of a syntax of SPS according to the embodiment.

FIG. 24 is a diagram illustrating an example of a syntax of SEI according to the embodiment.

FIG. 25 is a diagram illustrating an example of a syntax of attribute_partition_common_info2 according to the embodiment.

FIG. 26 is a flowchart of three-dimensional data encoding processing according to the embodiment.

FIG. 27 is a flowchart of three-dimensional data decoding processing according to the embodiment.

FIG. 28 is a block diagram of a variation of a three-dimensional data encoding device according to the embodiment.

FIG. 29 is a block diagram of a variation of a three-dimensional data decoding device according to the embodiment.

FIG. 30 is a diagram illustrating an example of merging and partitioning processes according to the embodiment.

FIG. 31 is a diagram illustrating an example of a syntax of SEI according to the embodiment.

FIG. 32 is a diagram illustrating an example of a syntax of attribute_partition_common_info3 according to the embodiment.

FIG. 33 is a flowchart of three-dimensional data decoding processing according to the embodiment.

FIG. 34 is a flowchart of three-dimensional data decoding processing according to the embodiment.

FIG. 35 is a flowchart of three-dimensional data encoding processing according to the embodiment.

FIG. 36 is a flowchart of three-dimensional data encoding processing according to the embodiment.

### DESCRIPTION OF EMBODIMENTS

A three-dimensional data decoding method according to an aspect of the present disclosure includes: obtaining control information indicating that first attribute information of a three-dimensional point and second attribute information of the three-dimensional point are to be merged; and decoding the first attribute information and the second attribute information according to the control information. The first attribute information and the second attribute information each have a predetermined length compliant with a point cloud compression standard.

Accordingly, the three-dimensional data decoding method can generate attribute information exceeding a length (size) compliant with the point cloud compression standard, by merging the first attribute information and the second attribute information that have been decoded by processing compliant with the point cloud compression standard. Therefore, processing of attribute information exceeding a length compliant with the point cloud compression standard can be realized.

A three-dimensional data decoding method according to an aspect of the present disclosure includes: obtaining control information indicating that attribute information of a three-dimensional point is provided over a plurality of sub-blocks each having a predetermined length compliant with a point cloud compression standard; and decoding the attribute information according to the control information.

Accordingly, the three-dimensional data decoding method can generate attribute information that is provided over a plurality of sub-blocks that have been decoded by processing compliant with the point cloud compression standard.

For example, the attribute information that is provided over the plurality of sub-blocks may indicate one item of information. Therefore, according to this aspect, the three-dimensional data decoding method can generate one item of attribute information having a length that is greater than a length compliant with the cloud point compression standard.

For example, the plurality of sub-blocks may have a same length. For example, the plurality of sub-blocks may be components of the attribute information or dimensions included in one component of the attribute information. Here, the components and the dimensions compliant with the point cloud compression standard.

Accordingly, the three-dimensional data decoding method can decode sub-blocks having lengths compliant with the point cloud compression standard, by using the component or the dimensions provided in advance according to the point cloud compression standard. Consequently, since a separate special container need not be used, compatibility with the point cloud compression standard can be maintained.

For example, the control information may include information indicating a correspondence relationship between the plurality of sub-blocks and the components or the dimensions.

Accordingly, the three-dimensional data decoding method can recognize the relationship between the components or the dimensions and the plurality of sub-blocks by using the control information. This correspondence relationship is used in merging a plurality of items of attribute information, for example.

For example, the control information may include transform information on transforming of the attribute information that is provided over the plurality of sub-blocks.

In this aspect, attribute information that is provided over a plurality of sub-blocks is transformed, and thus encoding efficiency may improve (i.e., the code amount may be reduced). Accordingly, the data amount to be processed by the three-dimensional data decoding method can be reduced.

For example, the transform information may include a first coefficient to be applied to a first sub-block among the plurality of sub-blocks and a second coefficient to be applied to a second sub-block among the plurality of sub-blocks, and the first coefficient and the second coefficient may be different from each other.

In this aspect, a different coefficient (transform coefficient) is used for each sub-block, and thus encoding efficiency may improve (i.e., the code amount may be reduced). Accordingly, the data amount to be processed by the three-dimensional data decoding method can be reduced.

For example, with regard to a plurality of items of attribute information of a three-dimensional point, when there is a tendency for the value of the first sub-block to be close to 0 and the value of the second sub-block to be close to a value other than 0, it may be possible to further reduce the code amount by performing different transforming processing for each sub-block value. More specifically, when 64-bit attribute information is provided over four 16-bit length sub-blocks, there are instances where, depending on the attribute information, there are instances where a size that can be expressed by 64 bits is not reached. In this case, since a certain number of high-order bits become 0, the code amount can be reduced by making the coefficient for the high-order 16-bit sub-block and the coefficient for the low-order sub-blocks different. When the tendency of the value is different for each sub-block as described above, the code amount can be reduced by applying a different coefficient for each sub-block.

For example, the control information may include additional transform information on transforming of the attribute information before being partitioned.

Accordingly, since a three-dimensional data encoding device can transform the attribute information before partitioning, encoding efficiency can be improved. Furthermore, the three-dimensional data decoding method can reconstruct the original attribute information by performing inverse transforming of the aforementioned transforming, using the additional transform information.

A three-dimensional data encoding method according to an aspect of the present disclosure includes: generating control information indicating that first attribute information of a three-dimensional point and second attribute information of the three-dimensional point are to be merged; encoding the first attribute information and the second attribute information; and generating a bitstream including the first attribute information and the second attribute information that have been encoded and the control information. The first attribute information and the second attribute information each have a predetermined length compliant with a point cloud compression standard.

Accordingly, a three-dimensional data decoding device that decodes the bitstream generated by the three-dimensional data encoding method can generate attribute information exceeding a length (size) compliant with the point cloud compression standard, by merging the first attribute information and the second attribute information that have been decoded by processing compliant with the point cloud compression standard. Therefore, processing of attribute information exceeding a length compliant with the point cloud compression standard can be realized.

A three-dimensional data encoding method according to an aspect of the present disclosure includes: generating control information indicating that attribute information of a three-dimensional point is provided over a plurality of sub-blocks each having a predetermined length compliant with a point cloud compression standard; encoding the attribute information; and generating a bitstream including the attribute information that has been encoded and the control information.

Accordingly, the three-dimensional data decoding device can generate attribute information that is provided over a plurality of sub-blocks that have been decoded by processing compliant with the point cloud compression standard.

For example, the attribute information that is provided over the plurality of sub-blocks may indicate one item of information.

Therefore, according to this aspect, the three-dimensional data decoding device can generate one item of attribute information having a length that is greater than a length compliant with the cloud point compression standard.

For example, the plurality of sub-blocks may have a same length. For example, the plurality of sub-blocks may be components of the attribute information or dimensions included in one component of the attribute information. Here, the components and the one component compliant with the point cloud compression standard.

Accordingly, the three-dimensional data encoding method can encode the plurality of sub-blocks having lengths compliant with the point cloud compression standard, by using the component or the dimensions provided in advance according to the point cloud compression standard. Consequently, since a separate special container need not be used, compatibility with the point cloud compression standard can be maintained.

For example, the control information may include information indicating a correspondence relationship between the plurality of sub-blocks and the components or the dimensions.

Accordingly, the three-dimensional data decoding device can recognize the relationship between the components or dimensions and the plurality of sub-blocks by using the control information. This correspondence relationship is used in merging a plurality of items of attribute information, for example.

For example, the control information may include transform information on transforming of the attribute information that is provided over the plurality of sub-blocks.

In this aspect, attribute information that is provided over a plurality of sub-blocks is transformed, and thus encoding efficiency may improve (i.e., the code amount may be reduced). Accordingly, the data amount to be processed by the three-dimensional data decoding device can be reduced.

For example, the transform information may include a first coefficient to be applied to a first sub-block among the plurality of sub-blocks and a second coefficient to be applied to a second sub-block among the plurality of sub-blocks, and the first coefficient and the second coefficient may be different from each other.

In this aspect, a different coefficient (transform coefficient) is used for each sub-block, and thus encoding efficiency may improve (i.e., the code amount may be reduced). Accordingly, the data amount to be processed by the three-dimensional data decoding device can be reduced.

For example, the control information may include additional transform information on transforming of the attribute information before being partitioned.

Accordingly, since the three-dimensional data encoding method can transform the attribute information before partitioning, encoding efficiency can be improved. Furthermore, the three-dimensional data decoding device can reconstruct the original attribute information by performing inverse transforming of the aforementioned transforming, using the additional transform information.

A three-dimensional data decoding device according to an aspect of the present disclosure includes: a processor; and memory. Using the memory, the processor: obtains control information indicating that first attribute information of a three-dimensional point and second attribute information of the three-dimensional point are to be merged; and decodes the first attribute information and the second attribute information according to the control information. The first attribute information and the second attribute information each have a predetermined length compliant with a point cloud compression standard.

Accordingly, the three-dimensional data decoding device can generate attribute information exceeding a length (size) compliant with the point cloud compression standard, by merging the first attribute information and the second attribute information that have been decoded by processing compliant with the point cloud compression standard. Therefore, processing of attribute information exceeding a length compliant with the point cloud compression standard can be realized.

A three-dimensional data decoding device according to an aspect of the present disclosure includes: a processor; and memory. Using the memory, the processor: obtains control information indicating that attribute information of a three-dimensional point is provided over a plurality of sub-blocks each having a predetermined length compliant with a point cloud compression standard; and decodes the attribute information according to the control information.

Accordingly, the three-dimensional data decoding device can generate attribute information that is provided over a plurality of sub-blocks that have been decoded by processing compliant with the point cloud compression standard.

A three-dimensional data encoding device according to an aspect of the present disclosure includes: a processor; and memory. Using the memory, the processor: generates control information indicating that first attribute information of a three-dimensional point and second attribute information of the three-dimensional point are to be merged; encodes the first attribute information and the second attribute information; and generates a bitstream including the first attribute information and the second attribute information that have been encoded and the control information. The first attribute information and the second attribute information each have a predetermined length compliant with a point cloud compression standard.

Accordingly, a three-dimensional data decoding device that decodes the bitstream generated by the three-dimensional data encoding device can generate attribute information exceeding a length (size) compliant with the point cloud compression standard, by merging the first attribute information and the second attribute information that have been decoded by processing compliant with the point cloud compression standard. Therefore, processing of attribute information exceeding a length compliant with the point cloud compression standard can be realized.

A three-dimensional data encoding device according to an aspect of the present disclosure includes: a processor; and memory. Using the memory, the processor: generates control information indicating that attribute information of a three-dimensional point is provided over a plurality of sub-blocks each having a predetermined length compliant with a point cloud compression standard; encodes the attribute information; and generates a bitstream including the attribute information that has been encoded and the control information.

Accordingly, the three-dimensional data decoding device can generate attribute information that is provided over a plurality of sub-blocks that have been decoded by processing compliant with the point cloud compression standard.

It is to be noted that these general or specific aspects may be implemented as a system, a method, an integrated circuit, a computer program, or a computer-readable recording medium such as a CD-ROM, or may be implemented as any combination of a system, a method, an integrated circuit, a computer program, and a recording medium.

Hereinafter, embodiments will be specifically described with reference to the drawings. It is to be noted that each of the following embodiments indicate a specific example of the present disclosure. The numerical values, shapes, materials, constituent elements, the arrangement and connection of the constituent elements, steps, the processing order of the steps, etc., indicated in the following embodiments are mere examples, and thus are not intended to limit the present disclosure. Among the constituent elements described in the following embodiments, constituent elements not recited in any one of the independent claims will be described as optional constituent elements.

### Embodiment

Hereinafter, three-dimensional data encoding devices and three-dimensional decoding devices according to the present embodiment will be described. A three-dimensional data encoding device encodes three-dimensional data to thereby generate a bitstream. A three-dimensional data decoding device decodes the bitstream to thereby generate three-dimensional data.

The three-dimensional data is, for example, point cloud data. A point cloud, which is a set of three-dimensional points, represents the three-dimensional shape of an object. The point cloud data includes geometry information and attribute information on the three-dimensional points. The geometry information indicates the three-dimensional position of each three-dimensional point. It should be noted that the geometry information may also be called position information. The geometry information is expressed in, for example, a Cartesian coordinate system or a polar coordinate system.

The attribute information indicates, for example, attributes such as the color, reflectance, and normal vector. One three-dimensional point may have one item of attribute information or may have a plurality of items of attribute information.

The three-dimensional data is not limited to point cloud data and may be other types of three-dimensional data, such as mesh data. Mesh data (also called three-dimensional mesh data) is a data format used for computer graphics (CG) and represents the three-dimensional shape of an object as a set of surface information items. For example, mesh data includes point cloud information (e.g., vertex information), which may be processed by techniques similar to those for point cloud data.

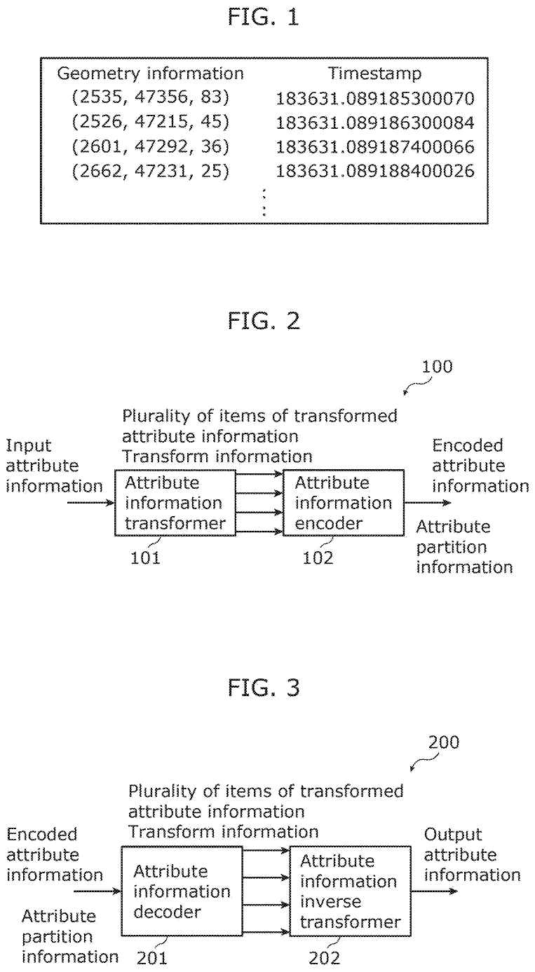

Now, an overview of the present embodiment will be described. FIG. 1 is a diagram illustrating an example of geometry information and attribute information of a point cloud, in which the attribute information is timestamps.

The timestamps are time information. For example, the timestamps are time information having a property defined as “timestamp” in the ply file format, time information defined as “GPS time” in the LAS file format, or time information in a protocol such as the Network Time Protocol (NTP) or the Precision Time Protocol (PTP).

In this case, the Sequence Parameter Set (SPS) stores information indicating attribute_type=“timestamp”, and a timestamp for each point is encoded as one component of the attribute information. The encoding method may be based on the Lifting scheme or the Region Adaptive Hierarchical Transform (RAHT) scheme. Alternatively, the attribute information may be stored as raw data in a bitstream without being encoded.

RAHT is a technique of transforming attribute information using geometry information on three-dimensional points. Transform such as Haar transform is applied to the attribute information to generate a high-frequency component and a low-frequency component for each layer, and their values are subjected to processing such as quantization and entropy encoding. Lifting, which is a transforming method using Level of Detail (LoD), involves calculating prediction residuals. LoD is a technique of hierarchizing three-dimensional points according to geometry information, in which the three-dimensional points are hierarchized according to the distances (sparsity or density) between the points.

The three-dimensional data encoding device may calculate and encode the difference between the absolute value of the timestamp and a predetermined value, or calculate and encode the difference between the timestamp of the current point and the timestamp of another point. Accordingly, the amount of information can be reduced. The order of encoding or decoding the points may be changed.

Generally, the bit depth of data supported by encoding and decoding systems is limited, and therefore methods or algorithms for encoding and decoding within the limited bit depth are specified. This allows maintaining realistic amounts of processing load and processing time.

Encoding and decoding systems for three-dimensional data (three-dimensional point cloud data or three-dimensional mesh data) is constrained by a limit on the bit depth of geometry information and attribute information to be encoded. The systems thus cannot process data with bit depths that exceed the limit.

It may also be possible that encoding and decoding systems support different bit depths depending on whether encoding is performed or not, or on the encoding method. For example, encoding and decoding systems that support encoding of up to 16 bits of attribute information cannot encode and decode attribute information with greater bit depths, such as 64-bit time information. Encoding and decoding systems that support encoding of up to 21 bits of geometry information cannot encode and decode geometry information with greater bit depths, such as 32-bit geometry information.

Further, three-dimensional data includes data generated by sensing the real physical world. The bit depth of geometry information is a value determined by the resolution of points and the range in space. The resolution of points depends on the performance of a sensor that obtains the point cloud, or on the distance to the object. The range in space depends on a use case or an application. That is, the bit depth may take a wide range of values, and the data includes many data items that exceed the bit depth limit supported by encoding and decoding systems. Similarly, attribute information includes various types of information, such as color, as well as reflectance, transmittance, infrared information, and time information, and the data includes many data items that exceed the bit depth limit supported by encoding and decoding systems. Three-dimensional data encoding and decoding systems thus need to rely on the limited bit depth to encode or decode information with various bit depths.

As above, processing three-dimensional data generated by sensing the real physical world requires conditions different from those required in encoding and decoding systems directed to data such as three-dimensional video, which has geometry information limited to a certain range of resolutions and attribute information limited to colors of a certain range of bit depths. A future increase in processing power due to device evolution may increase the bit depth supported by encoding and decoding systems. However, it will still be required for three-dimensional data encoding and decoding systems to have a capability to rely on the limited bit depth to encode or decode information with various bit depths.

In the present embodiment, input attribute information is partitioned into units (a plurality of items of transformed attribute information) that can be handled as attribute information in encoding. This allows encoding and decoding attribute information that exceeds the bit depth supported by systems in encoding and decoding. Transform information and attribute partition information are stored as metadata (SPS, APS, or SEI) in an encoded bitstream. The three-dimensional data decoding device can then reconstruct the input attribute information from the encoded bitstream. The present embodiment thus enables encoding and decoding attribute information with a bit depth not supported by constrained systems. The bit depth may also be expressed as the bit width or the bit precision.

FIG. 2 is a block diagram illustrating the configuration of three-dimensional data encoding device 100 according to the present embodiment. Although FIG. 2 shows only blocks related to attribute information encoding, three-dimensional data encoding device 100 may also include other processors, such as a geometry information encoder for geometry information encoding.

Three-dimensional data encoding device 100 includes attribute information transformer 101 and attribute information encoder 102. Attribute information transformer 101 partitions input attribute information into a plurality of items of transformed attribute information. Attribute information transformer 101 also generates transform information on transforming processing. The input attribute information is attribute information included in three-dimensional data to be encoded.

Attribute information encoder 102 encodes the plurality of items of transformed attribute information to generate encoded attribute information. Attribute information encoder 102 also generates attribute partition information that includes the transform information and that relates to the partitioning of the attribute information. Three-dimensional data encoding device 100 generates a bitstream that includes the encoded attribute information and the attribute partition information. Attribute information encoder 102 may use any encoding scheme, for example, one or more of intra-prediction processing, inter-prediction processing, quantization processing, and entropy encoding processing (arithmetic encoding processing).

FIG. 3 is a block diagram illustrating the configuration of three-dimensional data decoding device 200 according to the present embodiment. Although FIG. 3 shows only blocks related to attribute information decoding, three-dimensional data decoding device 200 may also include other processors, such as a geometry information decoder for geometry information decoding.

For example, three-dimensional data decoding device 200 decodes the bitstream generated by three-dimensional data encoding device 100. Three-dimensional data decoding device 200 includes attribute information decoder 201 and attribute information inverse transformer 202.

Attribute information decoder 201 obtains the encoded attribute information and the attribute partition information from the bitstream and decodes the encoded attribute information, thereby generating a plurality of items of transformed attribute information. Attribute information decoder 201 also obtains the transform information included in the attribute partition information. Attribute information decoder 201 may use any decoding scheme, for example, one or more of intra-prediction processing, inter-prediction processing, inverse quantization processing, and entropy decoding processing (arithmetic decoding processing).

Attribute information inverse transformer 202 uses the attribute partition information and the transform information to merge the plurality of items of transformed attribute information, thereby generating output attribute information. This output attribute information corresponds to the input attribute information in FIG. 2 and is a reconstruction of the input attribute information.

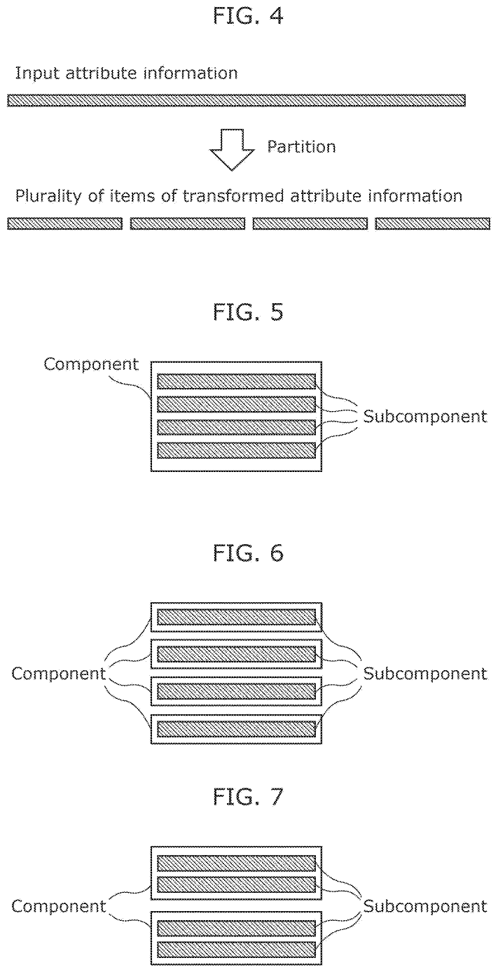

FIG. 4 is a diagram illustrating an example of partitioning input attribute information into a plurality of items of transformed attribute information. In FIG. 4, the input attribute information is partitioned into four items of transformed attribute information.

FIGS. 5, 6, and 7 are diagrams illustrating examples of encoding a plurality of items of transformed attribute information as one or more components in encoding systems. FIG. 5 is a diagram illustrating an example of encoding and decoding a plurality of items of transformed attribute information as multidimensional subcomponents of a single component (also referred to as an attribute component). Specifically, in the example illustrated in FIG. 5, attribute information (a timestamp) is encoded as a single component, in which each item of transformed attribute information is encoded as one subcomponent. That is, the component of the attribute information (timestamp) includes multiple subcomponents, each corresponding to one item of transformed attribute information.

Here, a component corresponds to the type of the attribute information, for example color, reflectance, or time information. Subcomponents correspond to dimensions (elements) in a component. For example, for a component of color in RGB, its subcomponents correspond to R, G, and B, respectively.

Thus, in the present embodiment, conventionally used dimensions (subcomponents) are used for encoding and decoding the partitioned attribute information (transformed attribute information). This allows encoding and decoding the partitioned attribute information without adding any new mechanism for storing the partitioned attribute information in the bitstream.

FIG. 6 is a diagram illustrating an example of encoding and decoding a plurality of items of transformed attribute information as multiple components. Specifically, in the example illustrated in FIG. 6, attribute information (a timestamp) is encoded as multiple components, in which each item of transformed attribute information is encoded as one component. That is, each component includes one subcomponent, which corresponds to one item of transformed attribute information.

FIG. 7 is a diagram illustrating an example of encoding and decoding a plurality of items of transformed attribute information as multiple components and multidimensional subcomponents. Specifically, in the example illustrated in FIG. 7, attribute information (a timestamp) is encoded as multiple components, in which the plurality of items of transformed attribute information are encoded as one of the multiple components. Each component includes multiple subcomponents, each corresponding to one item of transformed attribute information.

Three-dimensional data encoding device 100 may fixedly or selectively use any of the methods illustrated in FIGS. 5 to 7 of associating a plurality of items of transformed attribute information with one or more components.

Thus, for the plurality of items of transformed attribute information resulting from partitioning the input attribute information, three-dimensional data encoding device 100 uses any of the methods illustrated in FIGS. 5 to 7 to encode the items so that the items correspond to one or more components. Three-dimensional data encoding device 100 also stores, in the bitstream, information indicating the correspondence relationship between the plurality of items of transformed attribute information (partitioned components) and the one or more components. This allows three-dimensional data decoding device 200 to decode the plurality of items of transformed attribute information encoded by any of various methods, and merge the decoded items to reconstruct the input attribute information.

Attribute information transformer 101 performs processing such as partitioning processing and scale and offset processing on the input attribute information, and the processing of reordering data on points. Attribute information inverse transformer 202 performs processing such as merging processing and scale and offset processing on the plurality of items of transformed attribute information, and the processing of reordering data. This allows encoding and decoding various items of attribute information having different bit depths, different ranges of attribute information values, or different resolutions. Scale values and offset values used here are examples of the transform information or coefficients (a first coefficient and a second coefficient).

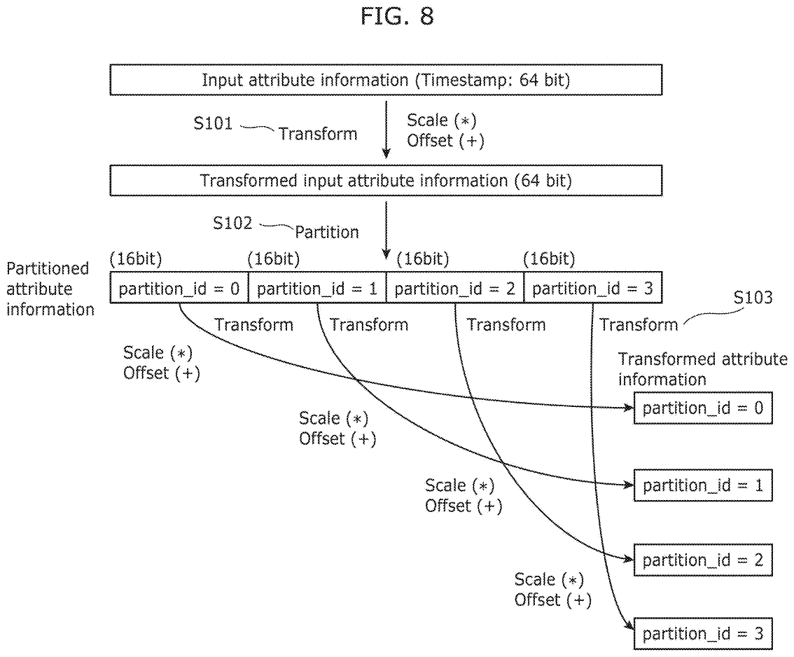

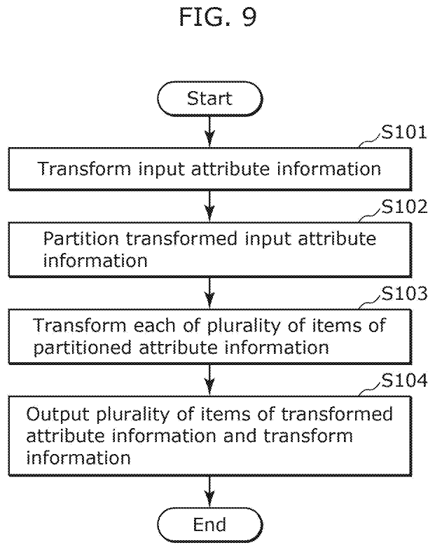

Now, an example of processing by attribute information transformer 101 will be described. FIG. 8 is a diagram illustrating an example of transforming processing in attribute information transformer 101. FIG. 9 is a flowchart of the transforming processing in attribute information transformer 101.

First, attribute information transformer 101 performs transforming processing on the entire input attribute information to generate transformed input attribute information (S101). Specifically, attribute information transformer 101 performs scale processing and offset processing on all the values of the input attribute information using (Equation 1) below.

$$val\_output = val\_input \times global\_scale + global\_offset \qquad ( Equation 1 )$$

The order of the scale processing and the offset processing may be reversed as in (Equation 2) below.

$$val\_output = ( val\_input + global\_offset ) \times global\_scale \qquad ( Equation 2 )$$

val_input denotes a value of the input attribute information, and val_output denotes a value of the transformed input attribute information. global_scale is a scale value used in the transforming processing, and global_offset is an offset value used in the transforming processing. global_scale and global_offset are examples of additional transform information.

Attribute information transformer 101 may perform only one of the scale processing and the offset processing, or even skip the transforming processing.

Attribute information transformer 101 partitions the transformed input attribute information into a plurality of items of partitioned attribute information (S102). In the example illustrated in FIG. 8, a timestamp with a bit depth of 64 bits is partitioned into four items of 16-bit partitioned attribute information.

At this point, attribute information transformer 101 assigns an identifier (partition_id) to each item of partitioned attribute information. The identifiers may be assigned in ascending order, in descending order, or in any manner.

Attribute information transformer 101 performs transforming processing (scale processing and offset processing) on each of the plurality of items of partitioned attribute information using a scale value (local_scale) and an offset value (local_offset), thereby generating a plurality of items of transformed attribute information (S103).

For example, an equation similar to (Equation 1) or (Equation 2) is used. Specifically, an equation is used that replaces global_scale and global_offset in (Equation 1) or (Equation 2) with local_scale and local_offset, respectively. This time, val_input denotes a value of the partitioned attribute information, and val_output denotes a value of the transformed attribute information.

Attribute information transformer 101 may perform only one of the scale processing and the offset processing, or even skip the transforming processing. Attribute information transformer 101 may perform quantization (round-off) processing after the scale processing. Different items of partitioned attribute information may be processed with different scale values and different offset values, or with the same scale value and the same offset value.

The above process thus generates the plurality of items of transformed attribute information. Attribute information transformer 101 outputs, to attribute information encoder 102, the plurality of items of transformed attribute information, as well as the transform information indicating parameters used in the partitioning and transforming (S104). Specifically, the transform information includes items such as global_scale, global_offset, local_scale, local_offset, partition_id, the bit depth of the input attribute information (or the transformed input attribute information), the bit depth of the partitioned attribute information (or the transformed attribute information), the partitioning order, and the partitioning method. Attribute information encoder 102 encodes the transform information as metadata. Attribute information encoder 102 stores the transform information in a bitstream.

Attribute information transformer 101 may perform the above transforming processing on all or some of the points that constitute the three-dimensional point cloud.

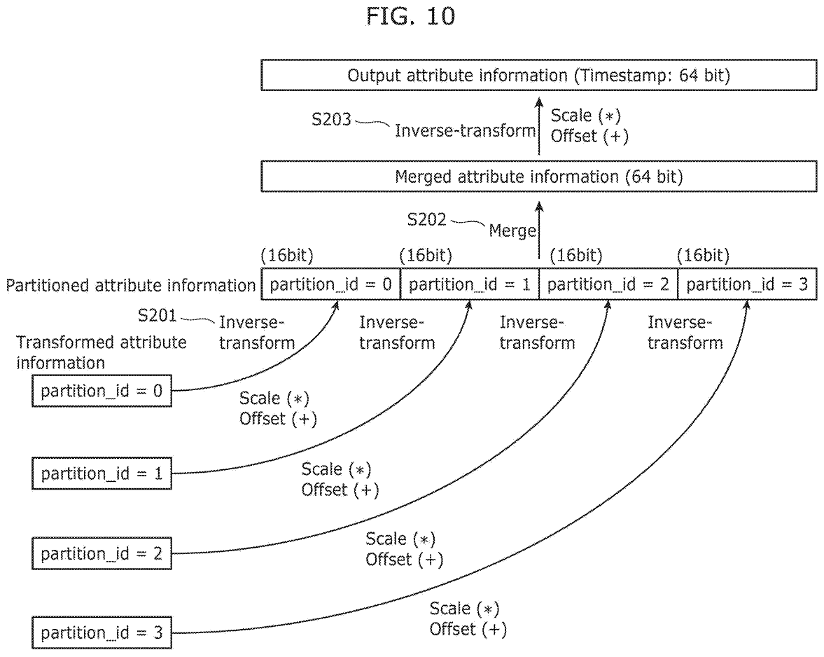

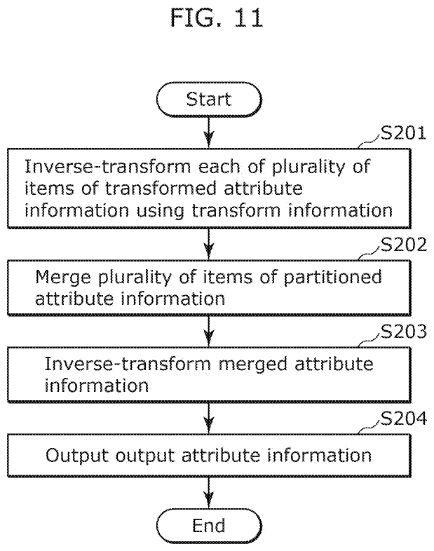

Now, an example of processing by attribute information inverse transformer 202 will be described. FIG. 10 is a diagram illustrating an example of inverse transforming processing in attribute information inverse transformer 202. FIG. 11 is a flowchart of the inverse transforming processing in attribute information inverse transformer 202.

First, attribute information decoder 201 decodes the plurality of items of transformed attribute information and obtains, from the metadata, the transform information (such as global_scale, global_offset, local_scale, local_offset, partition_id, the bit depth of the input attribute information (or the transformed input attribute information, the merged attribute information, or the output attribute information), the bit depth of the partitioned attribute information (or the transformed attribute information), the partitioning order, and the partitioning method).

Attribute information inverse transformer 202 inverse-transforms each of the plurality of items of transformed attribute information using the transform information, thereby generating a plurality of items of partitioned attribute information (S201). Specifically, attribute information inverse transformer 202 performs scale processing and offset processing on all the values of the transformed attribute information using (Equation 3) below.

$$val\_output = ( val\_decode + inv\_local \_offset ) \times inv\_local \_scale \qquad ( Equation 3 )$$

val_decode denotes a value of the transformed attribute information, and val_output denotes a value of the partitioned attribute information. inv_local_offset is an offset value used in the inverse transforming processing and corresponds to-(local_offset). inv_local_scale is a scale value used in the inverse transforming processing and corresponds to 1/local_scale.

The order of the scale processing and the offset processing may be reversed as in (Equation 4) below.

$$val\_output = ( val\_decode ) \times inv\_local \_scale + inv\_local \_offset \qquad ( Equation 4 )$$

Attribute information inverse transformer 202 may perform only one of the scale processing and the offset processing, or even skip the transforming processing. Different items of transformed attribute information may be processed with different scale values and different offset values, or with the same scale value and the same offset value.

Attribute information inverse transformer 202 merges the resulting plurality of items of partitioned attribute information to generate merged attribute information (S202). The specific manner of merging will be described later.

Attribute information inverse transformer 202 inverse-transforms the merged attribute information using a global scale value (inv_global_scale) and a global offset value (inv_global_offset), thereby generating output attribute information (S203).

For example, attribute information inverse transformer 202 performs inverse transforming processing using an equation similar to (Equation 3) or (Equation 4). Specifically, an equation is used that replaces inv_local_offset and inv_local_scale in (Equation 3) or (Equation 4) with inv_global_offset and inv_global_scale, respectively. This time, val_decode denotes a value of the merged attribute information, and val_output denotes a value of the output attribute information. inv_global_offset is an offset value used in the inverse transforming processing and corresponds to (global_offset). inv_global_scale is a scale value used in the inverse transforming processing and corresponds to 1/global_scale.

Attribute information inverse transformer 202 may perform only one of the scale processing and the offset processing, or even skip the transforming processing. Attribute information inverse transformer 202 may perform quantization (round-off) processing after the scale processing.

Lastly, attribute information inverse transformer 202 outputs the resulting output attribute information (S204).

Attribute information inverse transformer 202 may perform the above inverse transforming processing on all or some of the points that constitute the three-dimensional point cloud.

As above, three-dimensional data encoding device 100 stores, in the metadata, the transform information on the transforming processing by attribute information transformer 101, and sends the transform information to attribute information inverse transformer 202. This allows attribute information inverse transformer 202 to reconstruct the output attribute information corresponding to the input attribute information.

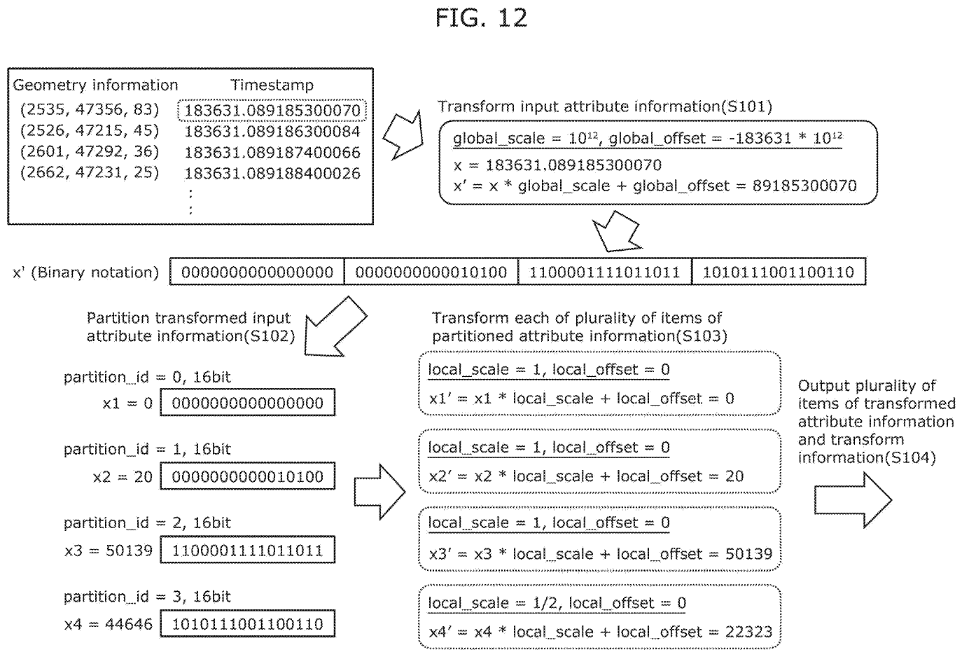

The following describes first specific examples of the processing in attribute information transformer 101 and attribute information inverse transformer 202. FIG. 12 is a diagram illustrating the first specific example of the processing in attribute information transformer 101.

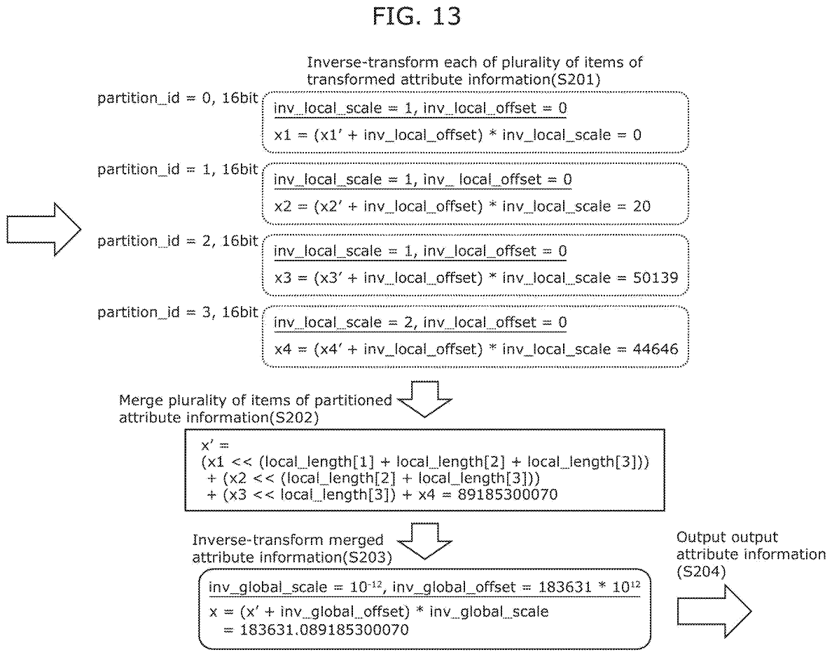

In the example illustrated in FIGS. 12 and 13, a timestamp is partitioned into four subcomponents and then encoded and decoded. The manner of partitioning illustrated here is a mere example and other manners are possible. FIGS. 12 and 13 omit illustration of the processing of encoding and decoding the plurality of items of transformed attribute information and the transform information.

The scale values and the offset values used by attribute information transformer 101 (global_scale, global_offset, local_scale, local_offset) may be determined by a user and input to three-dimensional data encoding device 100. Alternatively, three-dimensional data encoding device 100 may determine the scale values and the offset values based on the values of the attribute information on the points in the point cloud. Specifically, three-dimensional data encoding device 100 may analyze the general tendency of the values of the attribute information on the points in the point cloud and determine the scale values and the offset values based on the tendency. For example, three-dimensional data encoding device 100 may determine the offset values based on the average or median of the attribute information on the points.

The point cloud data may be point cloud data for multiple frames or for one frame. The scale values and the offset values may be common to a sequence (multiple frames) or any other processing unit. For example, one or more frames may use common values, or one or more processing units (e.g., slices) resulting from partitioning a frame may use common values.

In the example illustrated in FIG. 12, first, attribute information transformer 101 transforms input attribute information×(a timestamp) using global_scale=10¹² and global_offset=−183631×10¹², thereby generating transformed input attribute information x′ (S101).

Attribute information transformer 101 partitions transformed input attribute information x′ to generate four items of partitioned attribute information x1, x2, x3, and x4 (S102). Here, attribute information transformer 101 partitions transformed input attribute information x′ at intervals of a specified number of bits (16 bits in this example), starting at the most significant bit (MSB).

Attribute information transformer 101 transforms items of partitioned attribute information x1, x2, and x3 using local_scale=1 and local_offset=0 to generate items of transformed attribute information x1′, x2′, and x3′. It is to be noted that transforming using local_scale=1 and local_offset=0 is equivalent to performing no transforming, so that the transforming need not be performed. Attribute information transformer 101 transforms partitioned attribute information x4 using local_scale=½ and local_offset=0 to generate transformed attribute information x4′ (S103).

Lastly, attribute information transformer 101 outputs the four items of transformed attribute information x1′, x2′, x3′, and x4′ and the transform information (S104). This transform information includes global_scale and global_offset, and four pairs of local_scale and local_offset.

The example here illustrates the case in which only local_scale for one 16-bit block is different from local_scale for the other blocks. Alternatively, local_offset for at least one block may be different from local_offset for the other blocks, or both of local_scale and local_offset for at least one block may be different from local_scale and local_offset for the other blocks. Further, local_scale for each of the four blocks may be different from each other, and local_offset for each of the four blocks may be different from each other.

FIG. 13 is a diagram illustrating the first specific example of the processing in attribute information inverse transformer 202. Attribute information inverse transformer 202 inverse-transforms the four items of transformed attribute information x1′, x2′, x3′, and x4′ generated by the processing illustrated in FIG. 12 to generate four items of partitioned attribute information x1, x2, x3, and x4 (S201). Here, attribute information inverse transformer 202 calculates four pairs of inv_local_scale and inv_local_offset from the four pairs of local_scale and local_offset included in the transform information, and inverse-transforms the four items of transformed attribute information x1′, x2′, x3′, and x4′ using the calculated four pairs of inv_local_scale and inv_local_offset.

Attribute information inverse transformer 202 merges the four items of partitioned attribute information x1′, x2′, x3′, and x4′ to generate merged attribute information x′ (S202).

Assume that, as illustrated in FIG. 12, attribute information transformer 101 has partitioned the input attribute information by partitioning at intervals of a specified number of bits, starting at the MSB, and assigning partition_id in ascending order, starting from the MSB side. In this case, attribute information inverse transformer 202 merges the four items of partitioned attribute information x1′, x2′, x3′, and x4′ using partition_id and the number of bits of the partitioned attribute information (transformed attribute information) included in the transform information.

Specifically, the four items of information partitioned starting at the MSB are merged using (Equation 5) below, where local_length[1] to local_length[4] denote the numbers of bits of transformed attribute information x1 to x4, respectively, which are 16 in this example.

$${x}^{′} = ( x 1 << ( local\_length [ 1 ] + local\_length [ 2 ] + local\_length [ 3 ] ) ) + ( x 2 << ( local\_length [ 2 ] + local\_length [ 3 ] ) ) + ( x 3 << \text{local\_length[3]} ) + x 4 \qquad ( Equation 5 )$$

Attribute information inverse transformer 202 inverse-transforms merged attribute information x′ to generate output attribute information x (S203). Here, attribute information inverse transformer 202 calculates inv_global_scale and inv_global_offset from global_scale and global_offset included in the transform information, and inverse-transforms merged attribute information x′ using calculated inv_global_scale and inv_global_offset.

Lastly, attribute information inverse transformer 202 outputs resulting output attribute information x (S204).

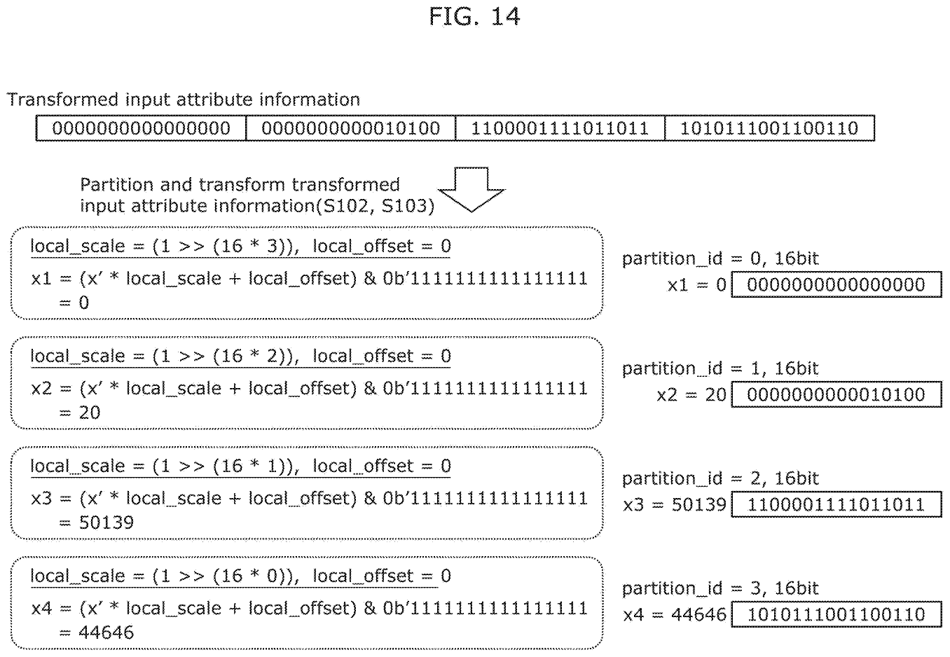

The following describes second specific examples of the processing in attribute information transformer 101 and attribute information inverse transformer 202. FIG. 14 is a diagram illustrating the second specific example, i.e., another example, of the processing in attribute information transformer 101. Transforming the input attribute information (S101) and outputting the plurality of items of transformed attribute information (S104) are the same as in FIG. 12 and therefore omitted.

In this example, attribute information transformer 101 uses the scale processing and the offset processing to collectively perform the partitioning (S102) and the transforming (S103) of the transformed input attribute information.

Specifically, attribute information transformer 101 performs round-off processing or clipping processing so that the values subjected to the scale processing and the offset processing are fit in the bit depth of the transformed attribute information (16 bits in this example). This can integrate the processing at S102 and S103. In this example, attribute information transformer 101 performs the processing of clipping values exceeding 16 bits out of the values subjected to the scale processing and the offset processing.

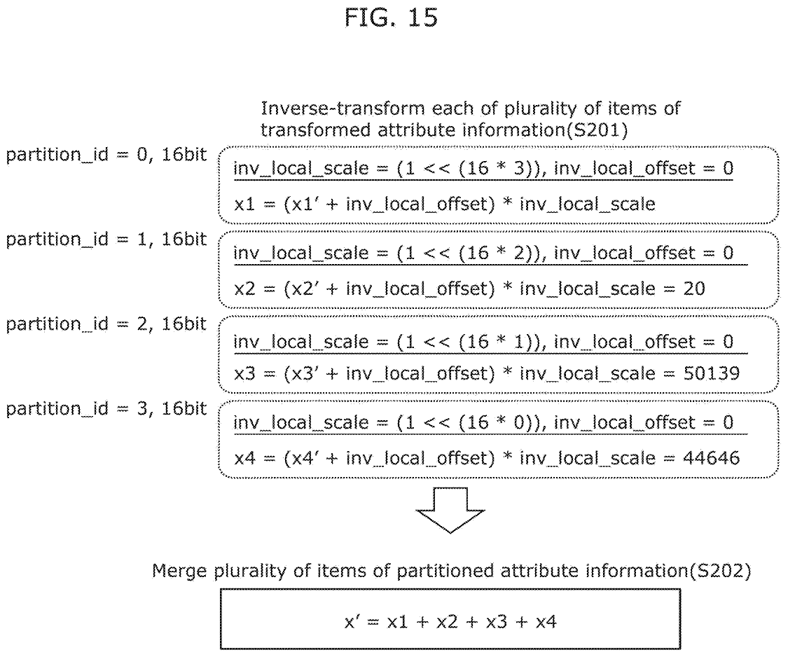

FIG. 15 is a diagram illustrating the second specific example, i.e., another example, of the processing in attribute information inverse transformer 202. Attribute information inverse transformer 202 calculates four pairs of inv_local_scale and inv_local_offset from the four pairs of local_scale and local_offset used in FIG. 14, and inverse-transforms the four items of transformed attribute information x1′, x2′, x3′, and x4′ using the calculated four pairs of inv_local_scale and inv_local_offset, thereby generating four items of partitioned attribute information x1, x2, x3, and x4 (S201).

Attribute information inverse transformer 202 adds up the four items of partitioned attribute information x1, x2, x3, and x4 to merge these four items (S202).

The above manner allows decoding without referring to the partitioning method, the partitioning order, or the bit depth of the transformed attribute information. This can reduce the information amount of the metadata (transform information).

The above description has illustrated the example in which the bit depth of the transformed attribute information is 16 bits, that is, the input attribute information exceeding 16 bits is partitioned. However, the bit depth of the transformed attribute information may be any value. The bit depth may be set at three-dimensional data encoding device 100. For example, the bit depth may be set according to the user's input. Alternatively, information indicating the bit depth may be stored in the bitstream.

This bit depth (e.g., 16 bits) is a bit depth (bit length) compliant with a point cloud compression standard (e.g., a point cloud coding (PCC) standard). The attribute information to be partitioned has a bit depth exceeding the above bit depth and not compliant with the point cloud compression standard.

Now, an example of encoding and decoding a plurality of items of input attribute information will be described. The above description has illustrated the example of partitioning a single item of input attribute information. A similar manner may be used for each of a plurality of items of input attribute information.

For example, a three-dimensional point cloud may have a plurality of items of input attribute information to be partitioned. The encoding system and the decoding system may support encoding and decoding data up to 16 bits. In this case, the following describes an example of encoding and decoding two or more items of attribute information exceeding 16 bits (such as 64-bit timestamps).

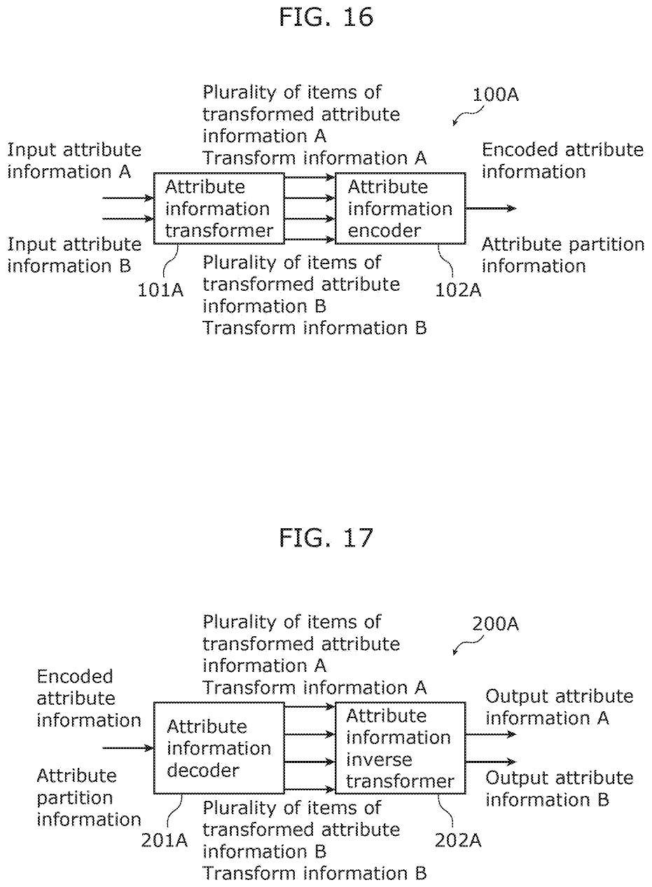

FIG. 16 is a block diagram illustrating a configuration of three-dimensional data encoding device 100A in this case. Three-dimensional data encoding device 100A includes attribute information transformer 101A and attribute information encoder 102A. Attribute information transformer 101A partitions input attribute information A into a plurality of items of transformed attribute information A, and partitions input attribute information B into a plurality of items of transformed attribute information B. Attribute information transformer 101A also generates transform information A on transforming processing for input attribute information A, and transform information B on transforming processing for input attribute information B. Input attribute information A and input attribute information B are attribute information included in three-dimensional data to be encoded. Input attribute information A and input attribute information B may be attribute information of the same type (e.g., timestamp) or different types.

Attribute information encoder 102A encodes the plurality of items of transformed attribute information A and the plurality of items of transformed attribute information B to generate encoded attribute information. Attribute information encoder 102A also generates attribute partition information that includes transform information A and transform information B. Three-dimensional data encoding device 100A generates a bitstream that includes the encoded attribute information and the attribute partition information.

FIG. 17 is a block diagram illustrating a configuration of three-dimensional data decoding device 200A in this case. For example, three-dimensional data decoding device 200A decodes the bitstream generated by three-dimensional data encoding device 100A. Three-dimensional data decoding device 200A includes attribute information decoder 201A and attribute information inverse transformer 202A.

Attribute information decoder 201A obtains the encoded attribute information and the attribute partition information from the bitstream and decodes the encoded attribute information, thereby generating a plurality of items of transformed attribute information A and a plurality of items of transformed attribute information B. Attribute information decoder 201A also obtains transform information A and transform information B included in the attribute partition information.

Attribute information inverse transformer 202A uses transform information A to merge the plurality of items of transformed attribute information A, thereby generating output attribute information A. Attribute information inverse transformer 202A uses transform information B to merge the plurality of items of transformed attribute information B, thereby generating output attribute information B. Output attribute information A corresponds to input attribute information A in FIG. 16, and output attribute information B corresponds to input attribute information B in FIG. 16.

Now, syntaxes of the transform information will be described. The transform information output from attribute information transformer 101 to attribute information encoder 102, and the transform information output from attribute information decoder 201 to attribute information inverse transformer 202 do not necessarily need to follow the syntax configurations below. Any syntax configurations may be employed that can notify the processor in the subsequent stage of the values in the syntaxes.

The transform information includes individual information corresponding to each of the plurality of items of transformed attribute information, and common information shared by the plurality of items of transformed attribute information. The transform information may include a plurality of items of common information. For example, for encoding and decoding a plurality of items of input attribute information as illustrated in FIGS. 16 and 17, a plurality of items of transform information for the respective items of input attribute information may be stored in the bitstream.

A group of a plurality of items of transformed attribute information to which the same common information is applied will hereinafter be referred to as an attribute partition group (partition_group). Thus, for a plurality of items of input attribute information, multiple (e.g., two) attribute partition groups may be set.

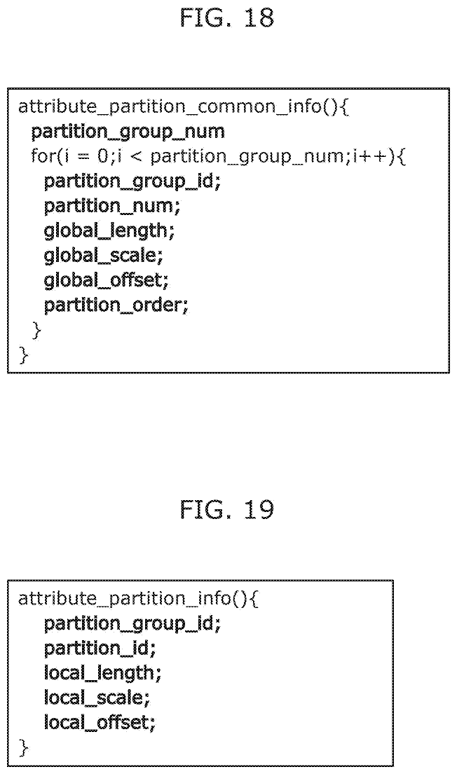

FIG. 18 is a diagram illustrating an example of a syntax of the common information (attribute_partition_common_info). The common information includes partition_group_num, partition_group_id, partition_num, global_length, global_scale, global_offset, and partition_order.
partition_group_num indicates the number of attribute partition groups. If there is one or more attribute partition groups, the common information includes, for each attribute partition group, partition-group common information (partition_group_id, partition_num, global_length, global_scale, global_offset, and partition_order) shared in the attribute partition group.
partition_group_id is an index indicating the attribute partition group. partition_group_id need not be stored if the description order of the information in the syntax matches the order of the values of this index.
partition_num indicates the number of partitioned items of attribute information in the attribute partition group. global_length indicates the total bit length of the attribute information before being partitioned (the input attribute information) that belongs to the attribute partition group.
global_scale indicates the scale value used to transform the attribute information before being partitioned (the input attribute information) in the attribute partition group. global_offset indicates the offset value used to transform the attribute information before being partitioned (the input attribute information) in the attribute partition group.
partition_order indicates the definition order of the identifiers (partition_id) of the plurality of items of transformed attribute information (the plurality of items of partitioned attribute information) belonging to the attribute partition group. For example, partition_order may indicate which of the most-significant-bit side and the least-significant-bit side of the input attribute information is the starting point of assigning partition_id. Specifically, partition_order=0 may indicate that the values of partition_id assigned to the plurality of items of transformed attribute information are set in ascending order, starting from the most-significant-bit side of the plurality of items of transformed attribute information. partition_order=1 may indicate that the values of partition_id assigned to the plurality of items of transformed attribute information are set in ascending order, starting from the least-significant-bit side of the plurality of items of transformed attribute information. This relationship between the value of partition_order and the setting order defined by partition_order may be reversed.

FIG. 19 is a diagram illustrating an example of a syntax of the individual information (attribute_partition_info). The individual information includes partition_group_id, partition_id, local_length, local_scale, and local_offset.
partition_group_id indicates the attribute partition group that includes the item of transformed attribute information to which this individual information is applied. In encoding or decoding the item of transformed attribute information, the common information having this partition_group_id is referred to.
partition_id indicates the identifier of the item of transformed attribute information. partition_id need not be stored if the description order of the individual information in the bitstream matches the order of the values of this identifier. For partition_order=0 in the common information, the values of partition_id assigned to the plurality of items of transformed attribute information may be set in ascending order, starting from the most-significant-bit side of the plurality of items of transformed attribute information. For partition_order=1, the values of partition_id assigned to the plurality of items of transformed attribute information may be set in ascending order, starting from the least-significant-bit side of the plurality of items of transformed attribute information. partition_id need not be stored if the three-dimensional data decoding device can determine the identifier of the item of transformed attribute information based on partition_order.
local_length indicates the bit length of the item of transformed attribute information. local_scale indicates the scale value used to transform the item of transformed attribute information. local_offset indicates the offset value used to transform the item of transformed attribute information.

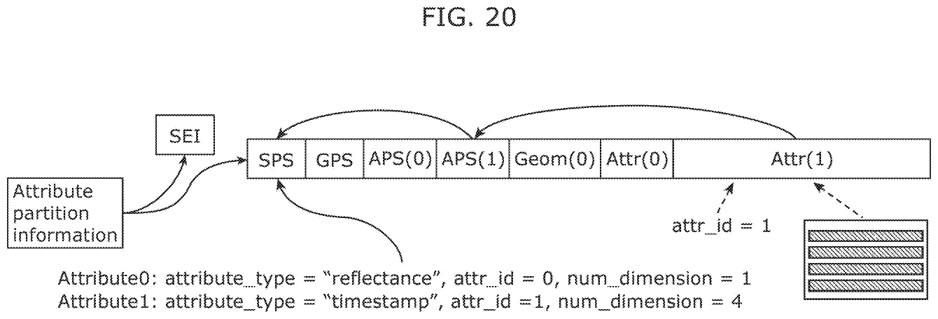

Now, a first example of encoding the plurality of items of transformed attribute information will be described. In the first example, as illustrated in FIG. 5, the plurality of items of transformed attribute information are encoded as multidimensional subcomponents of a single attribute component. FIG. 20 is a diagram illustrating an example configuration of a bitstream in this case.

The three-dimensional point includes geometry information and attribute information. The attribute information includes reflectance and time information (a timestamp). The reflectance has a bit depth capable of encoding as a single subcomponent, whereas the time information has a bit depth incapable of encoding as a single subcomponent. The reflectance is encoded as first attribute information, and the time information is encoded as second attribute information. The three-dimensional data encoding device partitions the time information into four to allow encoding as a single subcomponent, and encodes the time information as four-dimensional subcomponents.

The encoded data of the attribute information is data units each including a header and a payload, and the header of each data unit is assigned the identifier (attr_id) of the corresponding attribute component. Although the description here illustrates an example in which the attribute information includes time information, the attribute information may be of any other type.

The encoded data Attr(0) of the first attribute information has attr_id=0 stored in its header. The encoded data Attr(1) of the second attribute information has attr_id=1 stored in its header. The second attribute information is partitioned into four, resulting in four items of transformed attribute information. The four items of transformed attribute information are encoded as one attribute component, that is, as four-dimensional subcomponents of the attribute component.

Metadata related to the encoding is stored in the headers of the data units or in parameter sets (APSs). The three-dimensional data decoding device refers to this metadata to decode the encoded data. The Attribute Parameter Sets (APSs) are metadata (parameter sets) related to attribute information encoding, in which APS(0) is metadata on the first attribute information and APS(1) is metadata on the second attribute information. The APSs are metadata common to multiple frames, for example.

Geom(0) is the encoded data of the geometry information. The Geometry Parameter Set (GPS) is metadata (a parameter set) related to geometry information encoding. The GPS is metadata common to multiple frames, for example.

The Sequence Parameter Set (SPS) is metadata (a parameter set) common to multiple frames. The Supplemental Enhancement Information (SEI) is extension information that stores parameters (optional parameters) that might not necessarily be used in decoding.

The SPS includes information on an attribute component basis. Information on the first attribute component includes: identification information (attribute_type=reflectance) indicating that the first attribute information is reflectance; and information (num_dimension=1) indicating the number of dimensions of the first attribute information. Information on the second attribute component includes: identification information (attribute_type=timestamp) indicating that the second attribute information is time information; and information (num_dimension=4) indicating that the second attribute information has four-dimensional subcomponents.

The SPS or SEI includes attribute partition information that indicates the correspondence relationship between the partitioned input attribute information and the attribute component or subcomponents. The attribute partition information may further include the above-described transform information.

If there is no correlation among the subcomponents of the second attribute information, the three-dimensional data encoding device need not use inter-component prediction in encoding the second attribute information. Alternatively, inter-component prediction may be prohibited in encoding the second attribute information.

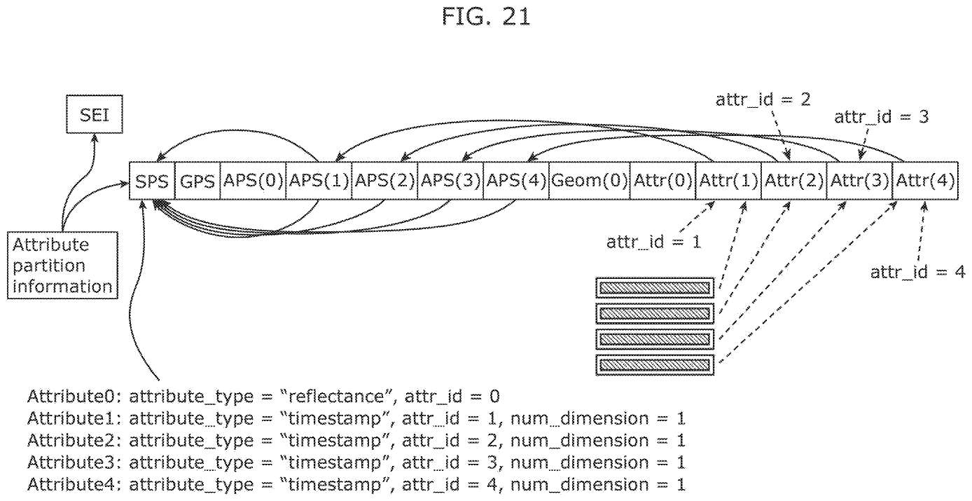

Now, a second example of encoding the plurality of items of transformed attribute information will be described. In the second example, as illustrated in FIG. 6, the plurality of items of transformed attribute information are encoded as multiple attribute components. FIG. 21 is a diagram illustrating an example configuration of a bitstream in this case.

The reflectance is encoded as first attribute information. The time information is partitioned into multiple (four) items to allow encoding as a single subcomponent, and encoded as second to fifth attribute information.

The four items of transformed attribute information are encoded as four attribute components, each including a one-dimensional subcomponent. The encoded data of each attribute component constitutes one data unit. The header of each data unit is assigned the identifier (attr_id) of the corresponding attribute component.

The first attribute information is the reflectance. The encoded data (Attr(0)) of the first attribute information is assigned attr_id=0 as the attribute component identifier. The second to fifth attribute information is the partitioned time information. The encoded data items (Attr(1) to (4)) of the second to fifth attribute information are assigned attr_id=1 to attr_id=4, respectively.

Metadata related to the encoding is stored in the headers of the data units or in parameter sets (APSs). The example in FIG. 21 shows that an APS is provided for each attribute component, so that five APSs correspond to the five respective attribute components. Multiple attribute components may share one parameter set.

The SPS includes: identification information (attribute_type=timestamp) indicating that the second to fifth attribute information is time information; and information (num_dimension=1) indicating that the second to fifth attribute information each has a one-dimensional subcomponent.

The SPS or SEI includes attribute partition information that indicates the correspondence relationship between the partitioned input attribute information and the attribute components or subcomponents. The attribute partition information may further include the above-described transform information.

It is to be noted that the three-dimensional data encoding device that assigns different items of transformed attribute information to different attribute components may encode these different components using different encoding schemes. For example, the three-dimensional data encoding device may assign the time information partitioned into four 16-bit items to four attribute components, and encode some of the attribute components using an encoding scheme such as Lifting or Raht and leave the rest of the attribute components as raw data.

For example, if the lower 16 bits of the 64-bit time information include a signal with no valid precision, that is, a random signal, the data of the lower 16 bits may be left as raw data without being encoded. This may prevent an increase in the amount of encoded bits.

The three-dimensional data encoding device may change, depending on the attribute components, encoding-related parameters and functions, such as a quantization parameter. For example, if the lower 8 bits of the 64-bit time information has no valid precision, the component of the lower 16 bits may be quantized while the components of the upper 48 bits are left unquantized.

In this case, each attribute component has a different parameter set (APS), which includes parameters related to the encoding of the corresponding attribute component. If the same encoding scheme is used for multiple attribute components, a common APS referred to these multiple attribute components may be used.

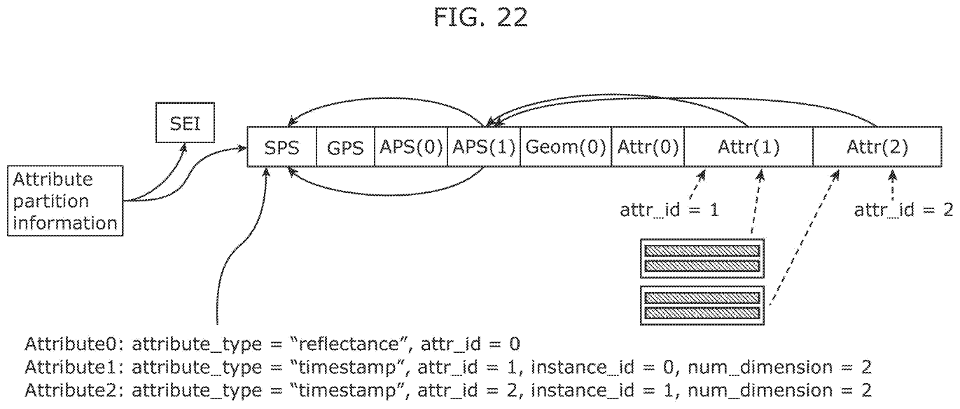

Now, a third example of encoding the plurality of items of transformed attribute information will be described. In the third example, as illustrated in FIG. 7, the plurality of items of transformed attribute information are encoded as multiple attribute components and multidimensional subcomponents. FIG. 22 is a diagram illustrating an example configuration of a bitstream in this case.

The reflectance is encoded as first attribute information. The time information is partitioned into multiple (four) items to allow encoding as a single subcomponent, and encoded as second and third attribute information using two-dimensional subcomponents.

The encoded data items Attr(1) and Attr(2) of the respective second and third attribute information are assigned attr_id=1 and attr_id=2, respectively. The second and third attribute information is each encoded as two-dimensional subcomponents corresponding to two items of transformed attribute information.

Metadata related to the encoding may be stored in APSs provided for the respective items of attribute information, or in an APS common to the plurality of items of attribute information.

The SPS includes: identification information (attribute_type=timestamp) indicating that the second and third attribute information is time information; and information (num_dimension=2) indicating that the second and third attribute information each has two-dimensional subcomponents.

If there is no correlation between the subcomponents of the second or third attribute information, the three-dimensional data encoding device need not use inter-component prediction in encoding the second or third attribute information.

The SPS or SEI includes attribute partition information that indicates the correspondence relationship between the partitioned input attribute information and the attribute components or subcomponents. The attribute partition information may further include the above-described transform information.

Now, a first example of a syntax of the attribute partition information will be described. The attribute partition information indicates the correspondence relationship between the partitioned attribute information (the plurality of items of transformed attribute information) and the attribute components and dimensions (subcomponents). The attribute partition information may include the above-described transform information.

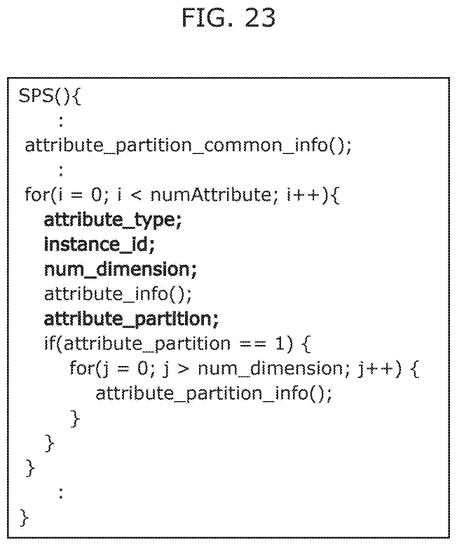

FIG. 23 is a diagram illustrating an example of a syntax of the SPS that includes the attribute partition information and the transform information. Alternatively, the attribute partition information and the transform information may be included in metadata such as the APSs or SEI, or in headers.

The attribute partition information includes attribute_type, instance_id, num_dimension, attribute_info, and attribute_partition.
numAttribute indicates the number of attribute components included in the sequence. The attribute partition information includes information (attribute_type, instance_id, num_dimension, attribute_info, and attribute_partition) on attribute components as many as the number indicated by numAttribute.
attribute_type indicates the attribute type. instance_id is an identifier within the attribute type. num_dimension indicates the number of dimensions (the number of subcomponents) of the attribute. attribute_info( ) includes detailed information on the attribute.
attribute_partition indicates whether the bitstream includes attribute partition information and transform information.

If the bitstream includes attribute partition information, the SPS includes attribute_partition_info( ) for each dimension.
attribute_partition_info( ) is the transform information for each dimension and has a syntax as illustrated in FIG. 19.

As illustrated in FIG. 19, attribute_partition_info( ) includes partition_id indicating the item of transformed attribute information. Therefore, partition_id is indicated in the loop of each dimension provided in the loop of each attribute component. Thus, the correspondence relationship between the transformed attribute information and the attribute components and dimensions (subcomponents) is indicated, that is, the attribute partition information is indicated.
attribute_partition_info( ) may also include transform information such as partition_length, partition_scale, and partition_offset. The SPS may include the common information (attribute_partition_common_info( )). For example, attribute_partition_common_info( ) may have a syntax as illustrated in FIG. 18. Instead of storing global_length, global_scale, or global_offset in the SPS, the three-dimensional data encoding device may store, in the SPS, APS, or SEI, information that functions equivalently to global_length, global_scale, or global_offset.

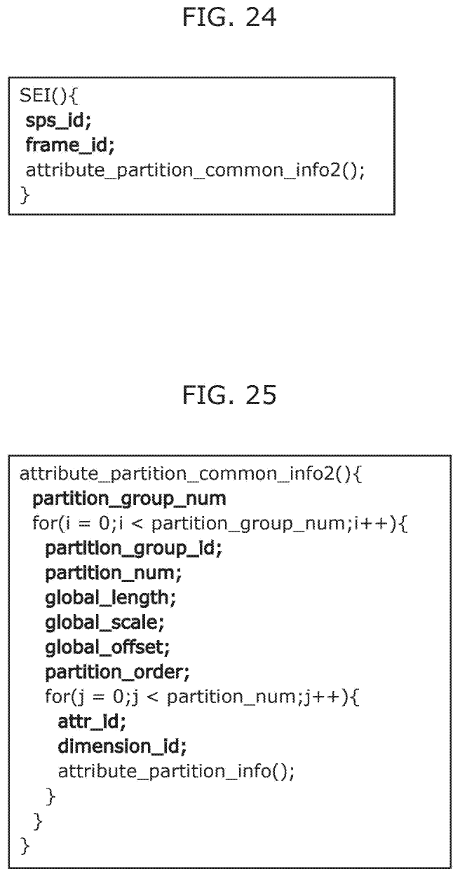

Now, a second example of syntaxes of the attribute partition information will be described. FIGS. 24 and 25 are diagrams illustrating examples of syntaxes of the attribute partition information. FIG. 24 is a diagram illustrating an example of a syntax of the SEI. It is to be noted that the syntaxes of the attribute partition information may be included in other places, such as headers.

The SEI includes identifiers indicating an encoding structure, such as the attribute components or dimensions in the SPS. Specifically, the SEI includes sps_id, frame_id, and attribute_partition_common_info2( ). sps_id indicates the identifier of the SPS to which the SEI corresponds. frame_id indicates the identifier of the frame corresponding to the attribute partition information, if the attribute partition information varies frame by frame. If the attribute partition information does not vary frame by frame, frame_id may be omitted.
attribute_partition_common_info2( ) is common transform information. FIG. 25 is a diagram illustrating an example of a syntax of attribute_partition_common_info2.

In addition to attribute_partition_common_info( ) illustrated in FIG. 18, attribute_partition_common_info2 includes individual information (attribute_partition_info( )), as well as the identifiers of the attribute components (attr_id) and the indexes of the dimensions (dimension_id) indicated in the SPS. attr_id and dimension_id may be omitted if they are defined in the description order (the definition order) of attribute_partition_info( ) in the SPS. attribute_partition_info( ) has a syntax as illustrated in FIG. 19, for example.

In this manner, the loop of the individual information may indicate partition_id, and the identifiers of the corresponding attribute component and dimension (subcomponent). Thus, the correspondence relationship between the plurality of items of transformed attribute information and the attribute components and dimensions (subcomponents) is indicated, that is, the attribute partition information is indicated.

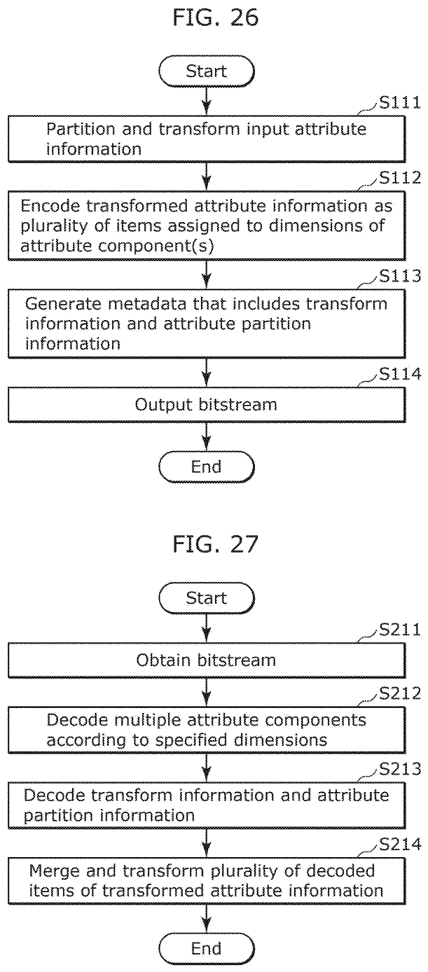

Now, processes in the three-dimensional data encoding device and the three-dimensional data decoding device will be described. FIG. 26 is a flowchart of three-dimensional data encoding processing by the three-dimensional data encoding device. First, the three-dimensional data encoding device partitions and transforms input attribute information (S111). Specifically, the processing at steps S101 to S104 described above and illustrated in FIG. 9 is performed.

The three-dimensional data encoding device encodes the transformed attribute information as a plurality of items assigned to the dimensions of one or more attribute components, thereby generating encoded attribute information (S112). Three-dimensional data encoding device generates metadata that includes transform information and attribute partition information (S113). Lastly, the three-dimensional data encoding device outputs a bitstream that includes the encoded attribute information and the metadata (S114).

FIG. 27 is a flowchart of three-dimensional data decoding processing by the three-dimensional data decoding device. First, the three-dimensional data decoding device obtains the bitstream (S211). The three-dimensional data decoding device decodes the attribute components from the bitstream according to the specified dimensions (S212). The three-dimensional data decoding device decodes (obtains) the transform information and the attribute partition information from the bitstream (S213). The three-dimensional data decoding device obtains, from the attribute partition information, the correspondence relationship between the data of each dimension of the decoded attribute components and partition_id.

The three-dimensional data decoding device merges and transforms the plurality of decoded items of transformed attribute information (S214). Specifically, steps S201 to S204 described above and illustrated in FIG. 11 are performed. The three-dimensional data decoding device refers to the correspondence relationship indicated in the attribute partition information to inverse-transform the transformed attribute information using the transform information corresponding to partition_id of the transformed attribute information.

The above description has illustrated the example in which the three-dimensional data encoding device partitions and encodes the input attribute information. In addition to or instead of partitioning, the device may merge a plurality of items of input attribute information and encode the merged attribute information as one component. Specifically, if a plurality of items of input attribute information with small bit depths are received, the three-dimensional data encoding device may merge these items and encode them as one item of attribute information.

For example, three-dimensional data encoding device may merge 4-bit input attribute information A and 4-bit input attribute information B and encode them as 8-bit attribute information C. This may reduce the encoding overhead to improve the coding efficiency. If the merge results in a large size of input attribute information, the three-dimensional data encoding device may partition the merged attribute information.

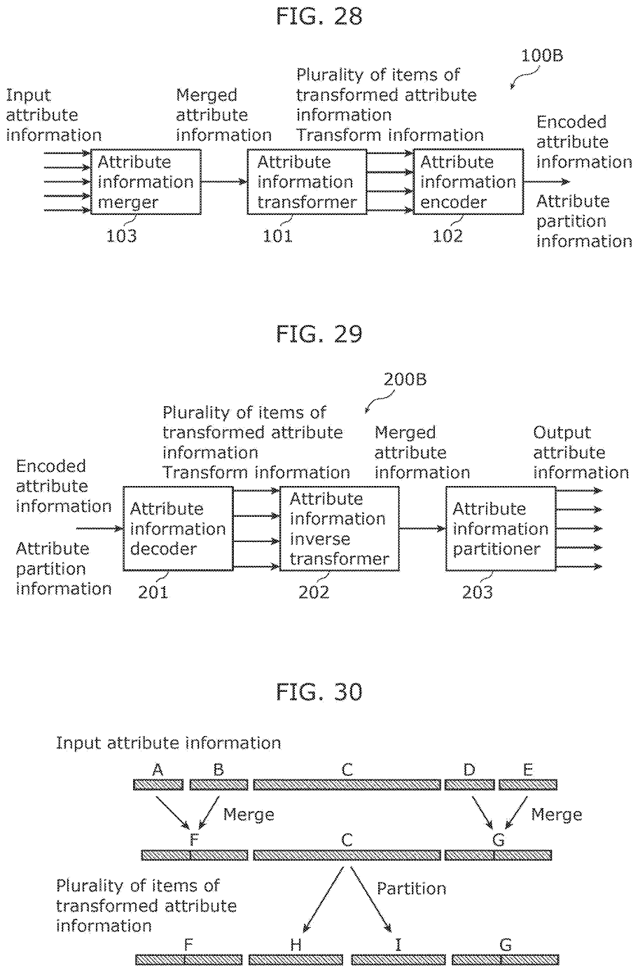

FIG. 28 is a block diagram illustrating a configuration of three-dimensional data encoding device 100B in this case. Three-dimensional data encoding device 100B includes attribute information merger 103, attribute information transformer 101, and attribute information encoder 102.

Attribute information merger 103 merges a plurality of items of input attribute information to generate merged attribute information. Attribute information merger 103 may merge only some of the plurality of items of input attribute information.

Attribute information transformer 101 transforms and partitions the merged attribute information to generate a plurality of items of transformed attribute information. Attribute information encoder 102 encodes the plurality of items of transformed attribute information to generate encoded attribute information. The processing in attribute information transformer 101 and attribute information encoder 102 is the same as in the above description, for example.

The merged attribute information is encoded using any attribute type, for example attribute_type=‘general_data’. For example, attribute_type is stored in the SPS. In this case, the above-described attribute partition information indicates the correspondence relationship between the plurality of merged and partitioned items of transformed attribute information and the attribute components or subcomponents.

FIG. 29 is a block diagram illustrating a configuration of three-dimensional data decoding device 200B in this case. For example, three-dimensional data decoding device 200B decodes the bitstream generated by three-dimensional data encoding device 100B. Three-dimensional data decoding device 200B includes attribute information decoder 201, attribute information inverse transformer 202, and attribute information partitioner 203.

Attribute information decoder 201 obtains the encoded attribute information and the attribute partition information from the bitstream and decodes the encoded attribute information, thereby generating a plurality of items of transformed attribute information. Attribute information inverse transformer 202 merges and inverse-transforms the plurality of items of transformed attribute information to generate merged attribute information. The processing in attribute information decoder 201 and attribute information inverse transformer 202 is the same as in the above description, for example.

Attribute information partitioner 203 partitions the merged attribute information to generate a plurality of items of output attribute information. The plurality of items of output attribute information correspond to the plurality of items of input attribute information in FIG. 28.

FIG. 30 is a diagram illustrating an example of merging and partitioning a plurality of items of input attribute information into a plurality of items of transformed attribute information. In FIG. 30, items of input attribute information A, B, D, and E have bits not greater than a predetermined first number of bits (e.g., 8 bits). Attribute information merger 103 merges the items of input attribute information A and B to generate merged attribute information F (transformed attribute information F), and merges the items of input attribute information D and E to generate merged attribute information G (transformed attribute information G). Input attribute information C has bits greater than a predetermined second number of bits (e.g., 16 bits). Attribute information transformer 101 partitions input attribute information C to generate items of transformed attribute information H and I.

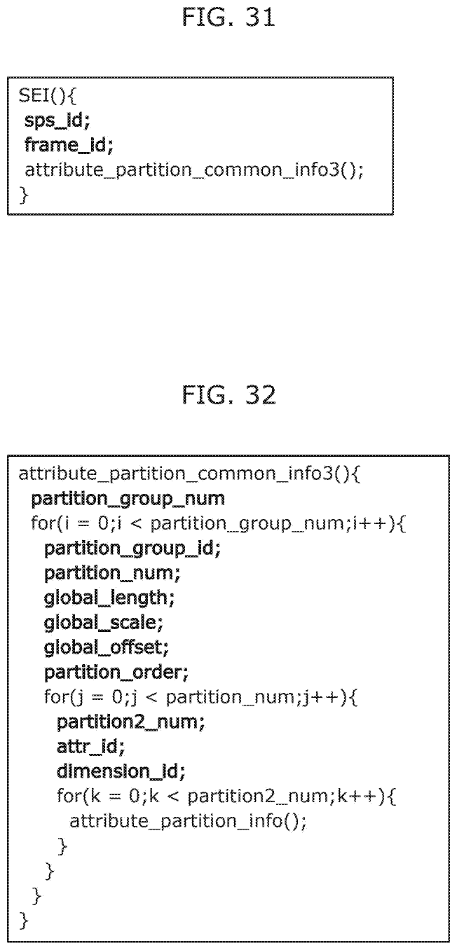

FIGS. 31 and 32 are diagrams illustrating examples of syntaxes of the attribute partition information. FIG. 31 is a diagram illustrating an example of a syntax of the SEI. It is to be noted that the syntaxes of the attribute partition information may be included in other places, such as headers.

The SEI includes sps_id, frame_id, and attribute_partition_common_info3( ). sps_id indicates the identifier of the SPS to which the SEI corresponds. frame_id indicates the identifier of the frame corresponding to the attribute partition information, if the attribute partition information varies frame by frame.
attribute_partition_common_info3( ) is common transform information. FIG. 32 is a diagram illustrating an example of a syntax of attribute_partition_common_info3.

The syntax shown in FIG. 32 is the syntax attribute_partition_common_info2 shown in FIG. 25 having partition2_num added thereto.
partition2_num indicates the number of merged items of input attribute information, if the attribute information of one component is data resulting from merging a plurality of items of input attribute information. Individual information (attribute_partition_info( )) is provided for each item of input attribute information before being merged.

In this manner, for each of the merged items of input attribute information, the identifiers of the attribute component and the dimension (subcomponent) corresponding to the item of input attribute information are indicated. Thus, the correspondence relationship between the merged items of input attribute information and the attribute components and dimensions (subcomponents) is indicated, that is, the attribute partition information is indicated.

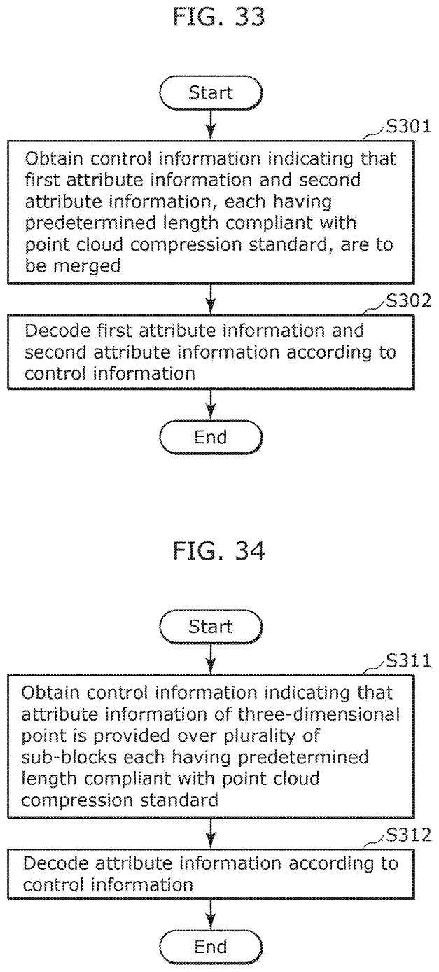

As described above, a three-dimensional data decoding device according to the present embodiment performs the process illustrated in FIG. 33. The three-dimensional data decoding device obtains control information (for example, SEI or SPS) indicating that first attribute information of a three-dimensional point and second attribute information of the three-dimensional point are to be merged (S301). The first attribute information and the second attribute information each have a predetermined length (for example, bit length or bit depth) compliant with a point cloud compression standard (for example, the PCC standard). The three-dimensional data decoding device decodes the first attribute information and the second attribute information according to the control information (S302).

Here, control information is, for example, SEI, SPS, or the like. For example, attribute_partition illustrated in FIG. 23 indicates whether or not first attribute information of a three-dimensional point and second attribute information of the three-dimensional point are to be merged. It should be noted that when the above-described transform information or attribute partition information, or at least a portion thereof, is included in the SEI or SPS, the three-dimensional data decoding device may determine that the first attribute information of the three-dimensional point and the second attribute information of the three-dimensional point are to be merged.

Accordingly, the three-dimensional data decoding device can generate attribute information exceeding a length (size) compliant with the point cloud compression standard, by merging the first attribute information and the second attribute information that have been decoded by processing compliant with the point cloud compression standard. Therefore, processing of attribute information exceeding a length compliant with the point cloud compression standard can be realized.

For example, the three-dimensional data decoding device may generate third attribute information by merging the first attribute information and second attribute information that have been decoded. For example, the third attribute information may exceed a predetermined length compliant with the point cloud compression standard

Furthermore, a three-dimensional data decoding device according to the present embodiment performs the process illustrated in FIG. 34. The three-dimensional data decoding device obtains control information indicating that attribute information of a three-dimensional point is provided over a plurality of sub-blocks each having a predetermined length compliant with a point cloud compression standard (S311), and decodes the attribute information according to the control information (S312).

Here, control information is, for example, SEI, SPS, or the like. For example, attribute_partition illustrated in FIG. 23 indicates whether or not attribute information of a three-dimensional point is provided over a plurality of sub-blocks. It should be noted that when the above-described transform information or attribute partition information, or at least a portion thereof, is included in the SEI or SPS, the three-dimensional data decoding device may determine that the attribute information of the three-dimensional point is provided over a plurality of sub-blocks.

Accordingly, the three-dimensional data decoding device can generate attribute information that is provided over a plurality of sub-blocks that have been decoded by processing compliant with the point cloud compression standard.

For example, the three-dimensional data decoding device generates attribute information by decoding each of the plurality of sub-blocks. For example, the three-dimensional data decoding device generates a plurality of items of first attribute information by decoding each of the plurality of sub-blocks, and generates second attribute information by merging the plurality of items of first attribute information. For example, the second attribute information may exceed a predetermined length compliant with the point cloud compression standard.

For example, the attribute information that is provided over the plurality of sub-blocks indicates one item of information. For example, the one item of information is a time stamp or the like, and is information indicating one value. Specifically, the information of each of the plurality of sub-blocks does not correspond to one component (for example, R component) of RGB or YUV. One item of information is information that can be counted as one unit of meaningful information. In other words, the information of each of the plurality of sub-blocks is information that is not meaningful individually, and meaningful information can be obtained by merging the information of the plurality of sub-blocks. Therefore, according to this aspect, the three-dimensional data decoding device can generate one item of attribute information having a length that is greater than a length compliant with the point cloud compression standard.

For example, the plurality of sub-blocks have the same length. It should be noted that at least part of the plurality of sub-blocks may be of a different length.

For example, the plurality of sub-blocks are components of the attribute information or dimensions (subcomponents) included in one component of the attribute information, the components and the dimensions compliant with the point cloud compression standard.

Accordingly, the three-dimensional data decoding device can decode sub-blocks having lengths compliant with the point cloud compression standard, by using the component or the dimensions provided in advance according to the point cloud compression standard. Consequently, since a separate special container need not be used, compatibility with the point cloud compression standard can be maintained.

For example, the control information includes information (for example, attribute partition information) indicating a correspondence relationship between the plurality of sub-blocks and the components or the dimensions. For example, the three-dimensional data decoding device generates a plurality of items of first attribute information by decoding each of the plurality of sub-blocks, and generates second attribute information by merging the plurality of items of first attribute information by using the information (for example, attribute partition information).

Accordingly, the three-dimensional data decoding device can recognize the relationship between the components or the dimensions and the plurality of sub-blocks by using the control information.

For example, the control information includes transform information on transforming of the attribute information that is provided over the plurality of sub-blocks. For example, the three-dimensional data decoding device inverse-transforms decoded attribute information by using the transform information. Here, transform information is, for example, is at least one of a scale value or an offset value.

Accordingly, since attribute information that is provided over a plurality of sub-blocks is transformed, encoding efficiency may improve (i.e., the code amount may be reduced). Accordingly, the data amount to be processed by the three-dimensional data decoding device can be reduced.

For example, the transform information includes a first coefficient to be applied to a first sub-block among the plurality of sub-blocks and a second coefficient to be applied to a second sub-block among the plurality of sub-blocks, and the first coefficient and the second coefficient are different from each other. For example, the three-dimensional data decoding device generates a plurality of items of first attribute information by decoding the plurality of sub-blocks, and inverse-transforms each of the plurality of items of first attribute information by using a coefficient (transform coefficient) corresponding to the first attribute information (sub-block). Here, the coefficient (each of the first coefficient and the second coefficient) is at least one of a scale value or an offset value.

Accordingly, since a different coefficient (transform coefficient) is used for each sub-block, encoding efficiency may improve (i.e., the code amount may be reduced). Accordingly, the data amount to be processed by the three-dimensional data decoding device can be reduced.

For example, with regard to a plurality of items of attribute information of a three-dimensional point, when there is a tendency for the value of the first sub-block to be close to 0 and the value of the second sub-block to be close to a value other than 0, it may be possible to further reduce the code amount by performing different transforming processing for each sub-block value. More specifically, when 64-bit attribute information is provided over four 16-bit length sub-blocks, there are instances where, depending on the attribute information, there are instances where a size that can be expressed by 64 bits is not reached. In this case, since a certain number of high-order bits become 0, the code amount can be reduced by making the coefficient for the high-order 16-bit sub-block and the coefficient for the low-order sub-blocks different. When the tendency of the value is different for each sub-block as described above, the code amount can be reduced by applying a different coefficient for each sub-block.

For example, the control information includes additional transform information (for example, at least one of global_scale and global_offset) about transforming of the attribute information before being partitioned. For example, the three-dimensional data decoding device generates a plurality of items of first attribute information by decoding the plurality of sub-blocks, generates second attribute information by merging the plurality of items of first attribute information, and inverse-transforms the second attribute information by using the additional transform information.

Accordingly, since a three-dimensional data encoding device can transform the attribute information before partitioning, encoding efficiency can be improved. Furthermore, the three-dimensional data decoding method can reconstruct the original attribute information by performing inverse transforming of the aforementioned transforming, using the additional transform information.

For example, the three-dimensional data decoding device includes a processor and memory, and the processor performs the above processes using the memory.

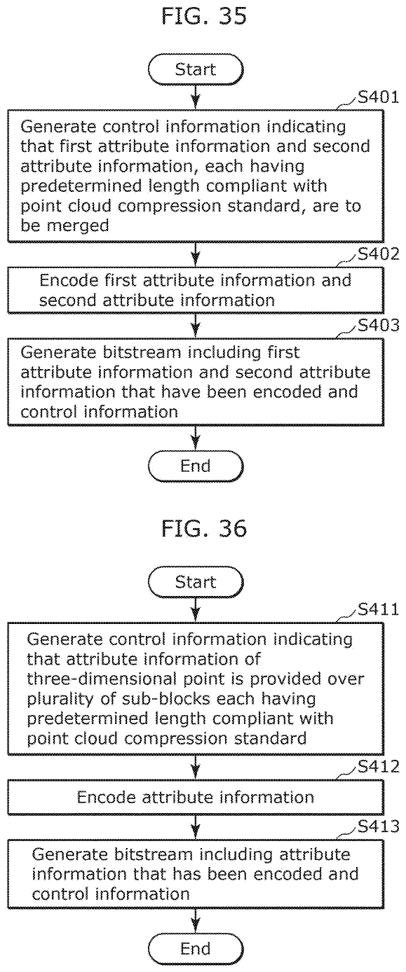

Furthermore, a three-dimensional data encoding device according to the present embodiment performs the process illustrated in FIG. 35. The three-dimensional data encoding device generates control information (for example, SEI or SPS) indicating that first attribute information of a three-dimensional point and second attribute information of the three-dimensional point are to be merged (S401). The first attribute information and the second attribute information each have a predetermined length (for example, bit length or bit depth) compliant with a point cloud compression standard (for example, the PCC standard). The three-dimensional data encoding device encodes the first attribute information and the second attribute information (S402), and generates a bitstream including the first attribute information and the second attribute information that have been encoded and the control information.

Here, control information is, for example, SEI or SPS, or the like. For example, attribute_partition illustrated in FIG. 23 indicates whether or not first attribute information of a three-dimensional point and second attribute information of the three-dimensional point are to be merged. It should be noted that when the above-described transform information or attribute partition information, or at least a portion thereof, is included in the SEI or SPS, the three-dimensional data decoding device may determine that the first attribute information of the three-dimensional point and the second attribute information of the three-dimensional point are to be merged.

Accordingly, a three-dimensional data decoding device that decodes the bitstream generated by the three-dimensional data encoding device can decode the first attribute information and the second attribute information by processing compliant with the point cloud compression standard. Furthermore, the three-dimensional data decoding device can generate attribute information exceeding a length compliant with the point cloud compression standard, by merging the first attribute information and the second attribute information that have been decoded. Therefore, processing of attribute information exceeding a length compliant with the point cloud compression standard can be realized.

For example, the three-dimensional data encoding device may generate first attribute information and second attribute information by partitioning third attribute information. For example, the third attribute information may exceed a predetermined length compliant with the point cloud compression standard.

Furthermore, a three-dimensional data encoding device according to the present embodiment performs the process illustrated in FIG. 36. The three-dimensional data encoding device generates control information indicating that attribute information of a three-dimensional point is provided over a plurality of sub-blocks each having a predetermined length compliant with a point cloud compression standard (S411), encodes the attribute information (S412), and generates a bitstream including the attribute information that has been encoded and the control information (S413).

Here, control information is, for example, SEI, SPS, or the like. For example, attribute_partition illustrated in FIG. 23 indicates whether or not attribute information of a three-dimensional point is provided over a plurality of sub-blocks. It should be noted that when the above-described transform information or attribute partition information, or at least a portion thereof, is included in the SEI or SPS, the three-dimensional data decoding device may determine that the attribute information of the three-dimensional point is provided over a plurality of sub-blocks.

Accordingly, the three-dimensional data decoding device can decode the plurality of sub-blocks by processing compliant with the point cloud compression standard. Furthermore, the attribute information can be processed even when the attribute information exceeds a length compliant with the point cloud compression standard.

For example, the three-dimensional data encoding device generates a plurality of items of second attribute information by partitioning first attribute information, and respectively provides the plurality of items of second attribute information in a plurality of sub-blocks. For example, the first attribute information may exceed a predetermined length compliant with the point cloud compression standard. Here, providing is storing the plurality of items of second attribute information in the plurality of sub-blocks, respectively. Stated differently, providing is encoding the plurality of items of second attribute information in association with the plurality of sub-blocks.

For example, the attribute information that is provided over the plurality of sub-blocks indicates one item of information. For example, the one item of information is, for example, a time stamp or the like, and is information indicating one value. Specifically, the information of each of the plurality of sub-blocks does not correspond to one component (for example, R component) of RGB or YUV. One item of information is information that can be counted as one unit of meaningful information. In other words, the information of each of the plurality of sub-blocks is information that is not meaningful individually, and meaningful information can be obtained by merging the information of the plurality of sub-blocks.

For example, the plurality of sub-blocks have the same length. It should be noted that at least part of the plurality of sub-blocks may be of a different length.

For example, the plurality of sub-blocks are components of the attribute information or dimensions (plurality of subcomponents) included in one component of the attribute information, the components and the dimensions compliant with the point cloud compression standard.

Accordingly, the three-dimensional data encoding device can encode the plurality of sub-blocks having lengths compliant with the point cloud compression standard, by using the component or the dimensions provided in advance according to the point cloud compression standard. Consequently, since a separate special container need not be used, compatibility with the point cloud compression standard can be maintained.

For example, the control information includes information (for example, attribute partition information) indicating a correspondence relationship between the plurality of sub-blocks and the components or the dimensions. For example, the three-dimensional data encoding device stores the information in the control information.

Accordingly, the three-dimensional data decoding device can recognize the relationship between the components or the dimensions and the plurality of sub-blocks.

For example, the control information includes transform information on transforming of the attribute information that is provided over the plurality of sub-blocks. For example, the three-dimensional data encoding device transforms the plurality of sub-blocks, and encodes the attribute information after the transforming. The transform information is about the transforming. Here, the transform information is, for example, is at least one of a scale value or an offset value.

Accordingly, since attribute information that is provided over a plurality of sub-blocks is transformed, encoding efficiency may improve (i.e., the code amount may be reduced). Accordingly, the data amount to be processed by the three-dimensional data decoding device can be reduced.

For example, the transform information includes a first coefficient to be applied to a first sub-block among the plurality of sub-blocks and a second coefficient to be applied to a second sub-block among the plurality of sub-blocks, and the first coefficient and the second coefficient are different from each other. For example, the three-dimensional data encoding device transforms each of the plurality of sub-blocks by using a coefficient (transform coefficient) corresponding to the sub-block. Here, the coefficient (each of the first coefficient and the second coefficient) is at least one of a scale value or an offset value.

Accordingly, since a different coefficient is used for each sub-block, encoding efficiency may improve (i.e., the code amount may be reduced). Accordingly, the data amount to be processed by the three-dimensional data decoding device can be reduced.

For example, the control information includes additional transform information (for example, at least one of global_scale and global_offset) about transforming of the attribute information before being partitioned. For example, the three-dimensional data encoding device generates second attribute information by transforming first attribute information (attribute information before partitioning), and generates a plurality of sub-blocks (a plurality of items of third attribute information) by partitioning the second attribute information. The additional transform information is about the transforming of the first attribute information.

Accordingly, since a three-dimensional data encoding device can transform the attribute information before partitioning, encoding efficiency can be improved. Furthermore, the three-dimensional data decoding method can reconstruct the original attribute information by performing inverse transforming of the aforementioned transforming, using the additional transform information.

For example, the three-dimensional data encoding device includes a processor and memory, and the processor performs the above processes using the memory.

A three-dimensional data encoding device, a three-dimensional data decoding device, and the like, according to embodiments of the present disclosure and variations of the embodiments have been described above, but the present disclosure is not limited to these embodiments, etc.

Note that each of the processors included in the three-dimensional data encoding device, the three-dimensional data decoding device, and the like, according to the above embodiments and variations thereof is typically implemented as a large-scale integrated (LSI) circuit, which is an integrated circuit (IC). These may take the form of individual chips, or may be partially or entirely packaged into a single chip.

Such IC is not limited to an LSI, and thus may be implemented as a dedicated circuit or a general-purpose processor. Alternatively, a field programmable gate array (FPGA) that allows for programming after the manufacture of an LSI, or a reconfigurable processor that allows for reconfiguration of the connection and the setting of circuit cells inside an LSI may be employed.

Moreover, in the above embodiments and variations thereof, the constituent elements may be implemented as dedicated hardware or may be realized by executing a software program suited to such constituent elements. Alternatively, the constituent elements may be implemented by a program executor such as a CPU or a processor reading out and executing the software program recorded in a recording medium such as a hard disk or a semiconductor memory.

The present disclosure may also be implemented as a three-dimensional data encoding method, a three-dimensional data decoding method, or the like executed by the three-dimensional data encoding device, the three-dimensional data decoding device, and the like.

Also, the divisions of the functional blocks shown in the block diagrams are mere examples, and thus a plurality of functional blocks may be implemented as a single functional block, or a single functional block may be divided into a plurality of functional blocks, or one or more functions may be moved to another functional block. Also, the functions of a plurality of functional blocks having similar functions may be processed by single hardware or software in a parallelized or time-divided manner.

Also, the processing order of executing the steps shown in the flowcharts is a mere illustration for specifically describing the present disclosure, and thus may be an order other than the shown order. Also, one or more of the steps may be executed simultaneously (in parallel) with another step.

A three-dimensional data encoding device, a three-dimensional data decoding device, and the like, according to one or more aspects have been described above based on the embodiments and variations thereof, but the present disclosure is not limited to these embodiments. The one or more aspects may thus include forms achieved by making various modifications to the above embodiments that can be conceived by those skilled in the art, as well forms achieved by combining constituent elements in different embodiments, without materially departing from the spirit of the present disclosure.

### Industrial Applicability

The present disclosure is applicable to a three-dimensional data encoding device and a three-dimensional data decoding device.

1. A three-dimensional data decoding method comprising:
obtaining, from a bitstream, control information indicating that a plurality of partitioned timestamp-information items of a three-dimensional point collectively represent timestamp information of the three-dimensional point, the control information including ordering information from which an order for reconstructing the timestamp information from the plurality of partitioned timestamp-information items is determinable;
decoding the plurality of partitioned timestamp-information items from the bitstream; and
reconstructing the timestamp information by merging the decoded plurality of partitioned timestamp-information items according to the order.

2. The three-dimensional data decoding method according to claim 1, wherein
the control information further includes partition_num indicating a number of the plurality of partitioned timestamp-information items.

3. The three-dimensional data decoding method according to claim 1, wherein
the control information further includes global_length indicating a total bit length of the timestamp information before partitioning.

4. The three-dimensional data decoding method according to claim 1, wherein
the ordering information includes partition_order indicating whether assignment of identifiers to the plurality of partitioned timestamp-information items starts from a most-significant-bit side or from a least-significant-bit side of the timestamp information.

5. The three-dimensional data decoding method according to claim 1, wherein
the control information includes partition_id for at least one of the plurality of partitioned timestamp-information items, or, when partition_id is omitted, an identifier of each partitioned timestamp-information item is determinable from a description order of the partitioned timestamp-information items in the bitstream.

6. The three-dimensional data decoding method according to claim 1, wherein
the control information is included in an SPS, an APS, an SEI message, or a header.

7. The three-dimensional data decoding method according to claim 1, wherein
the timestamp information is 64-bit timestamp information.

8. The three-dimensional data decoding method according to claim 7, wherein
the plurality of partitioned timestamp-information items consists of four items each having 16 bits.

9. The three-dimensional data decoding method according to claim 1, wherein
the control information further includes at least one of global_scale, global_offset, local_scale, or local_offset.

10. A three-dimensional data encoding method comprising:
partitioning timestamp information of a three-dimensional point into a plurality of partitioned timestamp-information items;
generating control information indicating that the plurality of partitioned timestamp-information items collectively represent the timestamp information, the control information including ordering information from which an order for reconstructing the timestamp information from the plurality of partitioned timestamp-information items is determinable;
encoding the plurality of partitioned timestamp-information items; and
generating a bitstream including the encoded plurality of partitioned timestamp-information items and the control information.

11. The three-dimensional data encoding method according to claim 10, wherein
the control information further includes partition_num indicating a number of the plurality of partitioned timestamp-information items.

12. The three-dimensional data encoding method according to claim 10, wherein
the control information further includes global_length indicating a total bit length of the timestamp information before partitioning.

13. The three-dimensional data encoding method according to claim 10, wherein
the ordering information includes partition_order indicating whether assignment of identifiers to the plurality of partitioned timestamp-information items starts from a most-significant-bit side or from a least-significant-bit side of the timestamp information.

14. The three-dimensional data encoding method according to claim 10, wherein
the control information includes partition_id for at least one of the plurality of partitioned timestamp-information items, or, when partition_id is omitted, an identifier of each partitioned timestamp-information item is determinable from a description order of the partitioned timestamp-information items in the bitstream.

15. The three-dimensional data encoding method according to claim 10, wherein
the control information is included in an SPS, an APS, an SEI message, or a header.

16. The three-dimensional data encoding method according to claim 10, wherein
the timestamp information is 64-bit timestamp information.

17. The three-dimensional data encoding method according to claim 16, wherein
the plurality of partitioned timestamp-information items consists of four items each having 16 bits.

18. The three-dimensional data encoding method according to claim 10, wherein
the control information further includes at least one of global_scale, global_offset, local_scale, or local_offset.

19. A three-dimensional data decoder comprising:
a processor; and
a memory coupled to the processor, wherein the processor:
obtains, from a bitstream, control information indicating that a plurality of partitioned timestamp-information items of a three-dimensional point collectively represent timestamp information of the three-dimensional point, the control information including ordering information from which an order for reconstructing the timestamp information from the plurality of partitioned timestamp-information items is determinable;
decodes the plurality of partitioned timestamp-information items from the bitstream; and
reconstructs the timestamp information by merging the decoded plurality of partitioned timestamp-information items according to the order.

20. A three-dimensional data encoder comprising:
a processor; and
a memory coupled to the processor, wherein the processor:
partitions timestamp information of a three-dimensional point into a plurality of partitioned timestamp-information items;
generates control information indicating that the plurality of partitioned timestamp-information items collectively represent the timestamp information, the control information including ordering information from which an order for reconstructing the timestamp information from the plurality of partitioned timestamp-information items is determinable;
encodes the plurality of partitioned timestamp-information items; and
generates a bitstream including the encoded plurality of partitioned timestamp-information items and the control information.
